(19) United States
(12) Patent Application Publication
(10) Pub. No.: US 2025/0386366 A1
(43) Pub. Date: Dec. 18, 2025

(54) PSSCH AND PSFCH FOR WIDEBAND OPERATION

(71) Applicant: QUALCOMM Incorporated, San Diego, CA (US)

(72) Inventors: Siyi CHEN, Beijing (CN); Jing SUN, San Diego, CA (US); Chih-Hao LIU, San Diego, CA (US); Xiaoxia ZHANG, San Diego, CA (US); Changlong XU, Beijing (CN); Shaozhen GUO, Beijing (CN); Luanxia YANG, Beijing (CN); Hao XU, Beijing (CN)

(21) Appl. No.: 18/876,081

(22) PCT Filed: Jul. 20, 2022
(86) PCT No.: PCT/CN2022/106731

§ 371 Date: Dec. 17, 2024

(51) Int. Cl. H04W 74/0808; H04W 72/40

(52) U.S. Cl. CPC H04W 74/0808; H04W 72/40

(57) ABSTRACT

A UE may be configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH. The SL transmission may be transmitted or refrained from being transmitted based on a first measurement of the first LBT bandwidth of the PSSCH being greater than a threshold value. The UE may receive a parameter associated with transmitting the SL transmission in the at least one RB set associated with the plurality of LBT bandwidths other than the first LBT bandwidth of the PSSCH.

### TECHNICAL FIELD

The present disclosure relates generally to communication systems, and more particularly, to a method of wireless sidelink communication including configuring physical sidelink shared channel (PSSCH) and physical sidelink feedback channel (PSFCH) for wideband operation in a 5G new radio unlicensed (NR-U) sidelink.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a UE, and the UE may be a transmit (Tx) UE or a receive (Rx) UE. The Tx UE may be configured to measure each of a plurality of LBT bandwidths of a physical sidelink shared channel (PSSCH), and refrain from transmitting a SL transmission in the PSSCH or transmit the SL transmission in at least one resource block (RB) set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. The Rx UE may be configured to receive a SL transmission in a PSSCH from a Tx UE, the PSSCH including a plurality of LBT bandwidths associated with at least one RB set, and transmit a physical sidelink feedback channel (PSFCH) including a hybrid automatic repeat request (HARQ) feedback of the PSSCH, the PSFCH being mapped to a starting sub-channel of each RB set of the plurality of LBT bandwidths of the PSSCH.

In an aspect of the disclosure, a method, a computer-readable medium, and an apparatus are provided. The apparatus may include a network node, the network node may be configured to receive an indication of at least one capability of a UE or a request from the UE, and transmit at least one parameter for the UE based at least in part on receiving the indication of the at least one capability of the UE or the request from the UE, where the at least one parameter indicates to the UE to transmit the SL transmission in the at least one RB set associated with the plurality of LBT bandwidths other than the first LBT bandwidth of the PSSCH.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a base station and user equipment (UE) in an access network.

FIG. 4 is a diagram illustrating example resources for sidelink communications.

FIG. 5 is an example of assigning PSFCH resources in sidelink communication.

FIG. 6A is a diagram of a PSSCH transmission.

FIG. 6B is a diagram of a PSSCH transmission.

FIG. 6C is a diagram of a PSSCH transmission.

FIG. 6D is a diagram of a PSSCH transmission.

FIG. 7A is a diagram of a PSSCH transmission.

FIG. 7B is a diagram of a PSSCH transmission.

FIG. 7C is a diagram of a PSSCH transmission.

FIG. 8 is a diagram 800 of PSSCH to PSFCH mapping.

FIG. 9 is a call-flow diagram of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

In a sidelink on unlicensed bands (SL-U) configured with the wideband operation, not every listen-before-talk (LBT) bandwidths may be available for a transmitting (Tx) user equipment (UE) to transmit PSSCH. Some aspects of the current disclosure may provide PSSCH transmission policy for different scenarios with at least one of the plurality of LBT bandwidths not being available for the Tx UE to transmit the PSSCH.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

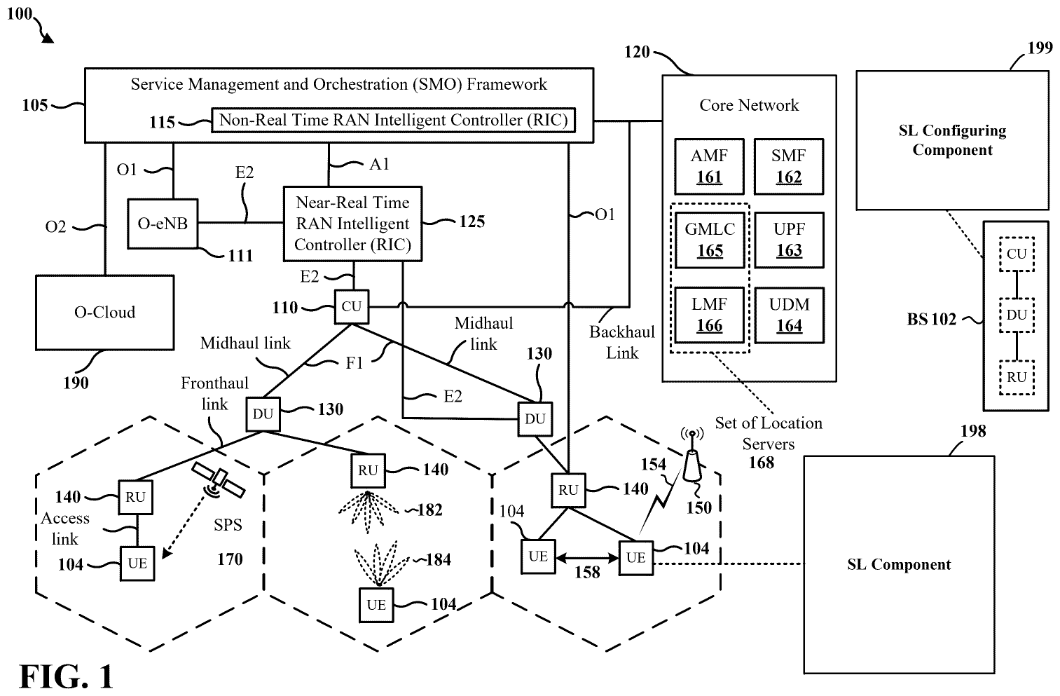

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E₁ interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be a Tx UE and include an SL component 198 configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. in certain aspects, the UE 104 may be a Rx UE and include an SL component 198 configured to receive a SL transmission in a PSSCH from a Tx UE, the PSSCH including a plurality of LBT bandwidths associated with at least one RB set, and transmit a PSFCH including a HARQ feedback of the PSSCH, the PSFCH being mapped to a starting sub-channel of each RB set of the plurality of LBT bandwidths of the PSSCH. In certain aspects, the base station 102 may include an SL configuring component 199 configured to receive an indication of at least one capability of a UE or a request from the UE, and transmit at least one parameter for the UE based at least in part on receiving the indication of the at least one capability of the UE or the request from the UE, where the at least one parameter indicates to the UE to transmit the SL transmission in the at least one RB set associated with the plurality of LBT bandwidths other than the first LBT bandwidth of the PSSCH. Although the following description may be focused on 5G NR, the concepts described herein may be applicable to other similar areas, such as LTE, LTE-A, CDMA, GSM, and other wireless technologies.

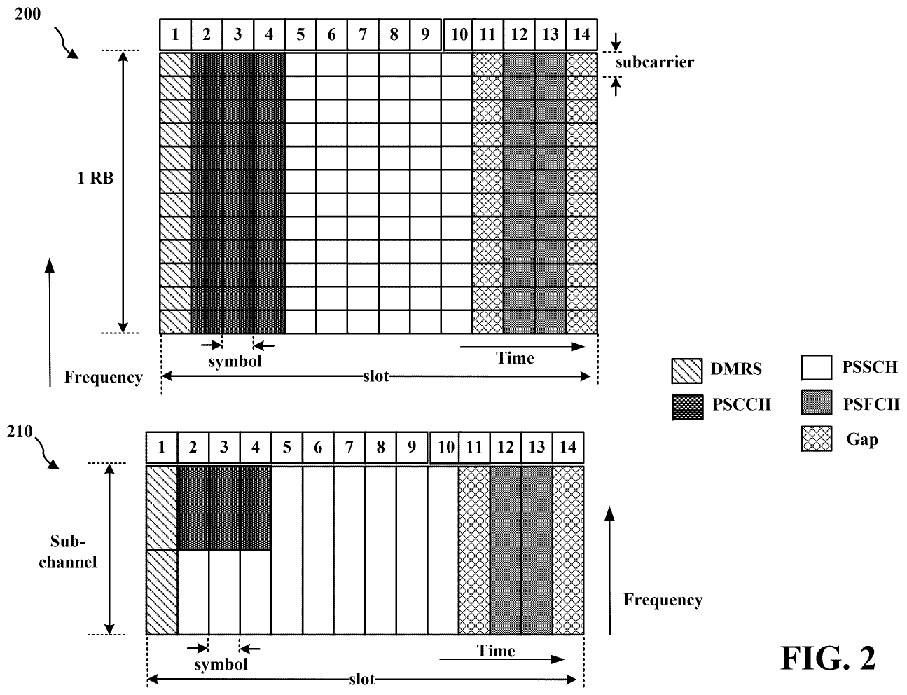

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information in PSCCH and some Res may comprise demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

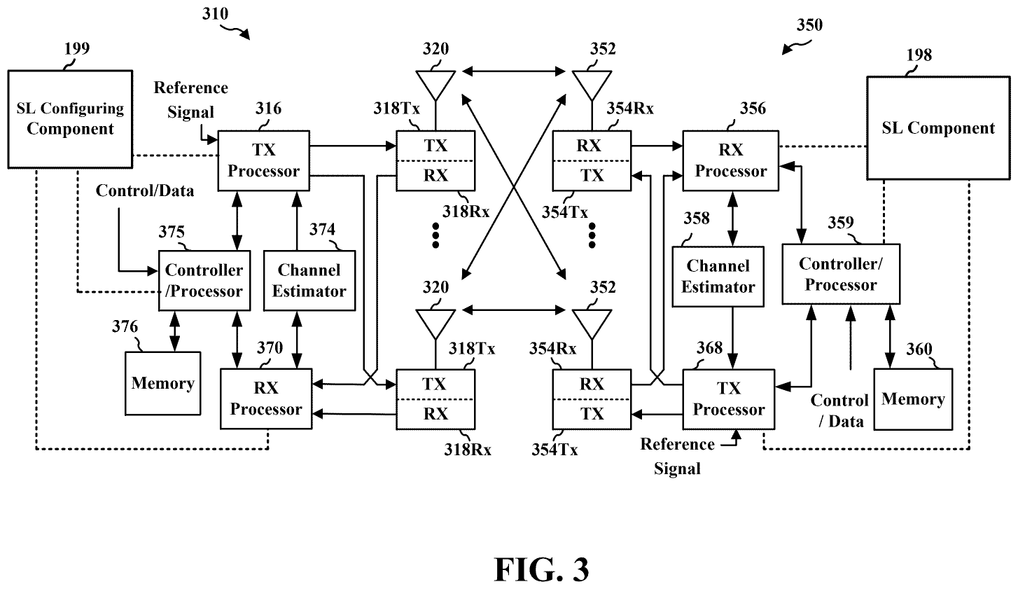

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through a hybrid automatic repeat request (HARQ), priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SL component 198 of FIG. 1. At least one of the TX processor 316, the RX processor 370, and the controller/processor 375 may be configured to perform aspects in connection with the SL configuring component 199 of FIG. 1.

For UE-UTRAN (Uu) communications in a 5G new radio unlicensed (NR-U), the network node and the UE may perform a CCA to transmit downlink (DL) or uplink (UL) transmissions, respectively. If the CCA is not successful for a single active BWP, the transmissions of the PDSCH and the PUSCH may be configured differently.

In one aspect, for transmitting the PDSCH, the network node may be configured to transmit partial PDSCH in at least a portion of the active BWP that the CCA is successful. That is, the network node may transmit the PDSCH in at least a portion of the single active BWP based on the CCA where the at least a part of the single active BWP is clear for data transmission, and the network node may transmit the PDSCH in the entire active BWP based on the CCA that the whole single active BWP is clear for data transmission. The UE may receive the PDSCH based on the DL scheduling information, as scheduled within a single listen-before-talk (LBT) bandwidth or over multiple LBT bandwidths.

In another aspect, for transmitting the PUSCH, the UE may take an “all or nothing” approach. That is, the UE may transmit the PUSCH based on the CCA that all LBT bandwidths of the scheduled PUSCH are clear for transmission at the UE's side. The UE is not expected to receive resource allocations in discontinuous LBT bandwidths within a wideband carrier.

For SL communications, such as a physical sidelink control channel (PSCCH) or physical sidelink shared channel (PSSCH) transmission, the transmitting UE may request an acknowledgment/negative acknowledgment (ACK/NACK or A/N) for a PSSCH. As an example, a UE that is receiving the PSSCH may transmit an ACK in a PSFCH if the PSSCH is accurately received and/or may transmit a NACK in the PSFCH if the PSSCH is not accurately received. PSFCH resource may be from, or associated with, a resource pool configured for multiple UEs, e.g., rather than from a dedicated PSFCH resource pool.

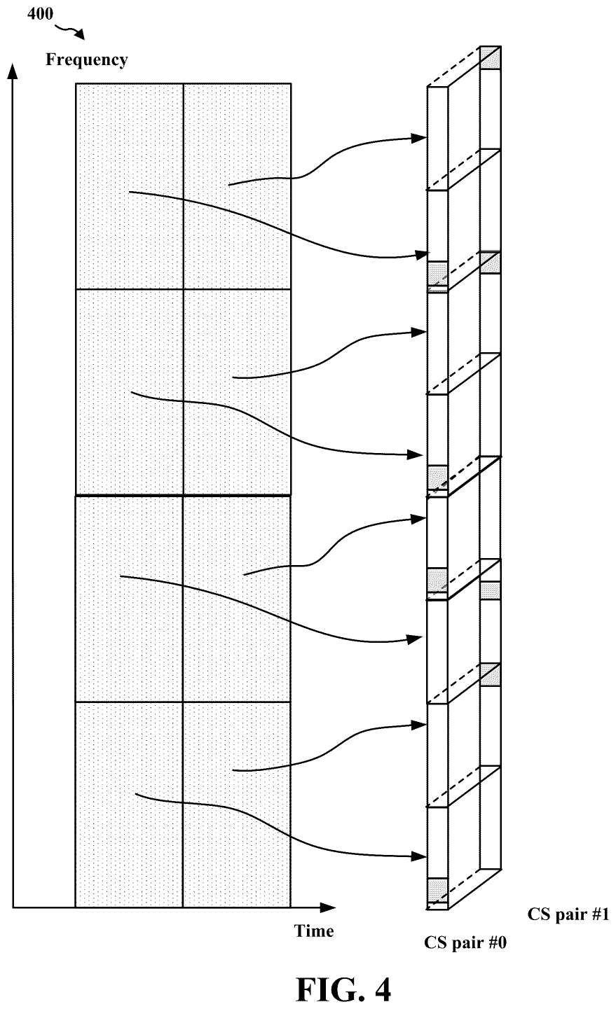

FIG. 4 is a diagram 400 illustrating example resources for sidelink communications. Cyclic shift (CS) pair #1 and CS pair #0 are illustrated in FIG. 4. A time period parameter, e.g., periodPSFCHresource, may be provided to a UE and may represent a period in slots for PSFCH transmission in the resource pool. In some examples, the parameter periodPSFCHresource may be 0, 1, 2, or 4 (0 representing no PSFCH, 1 representing 1 slot, 2 representing 2 slots, and 4 representing 4 slots). In some aspects, a PSFCH transmission timing may be the first slot with a PSFCH resource after a PSSCH or after a gap (which may be represented by a MinTimeGapPSFCH parameter) after the PSSCH. In some aspects, a set of PRBs in a resource pool for a PSFCH in a slot may be configured for the UE and may be represented by a parameter sl-PSFCH-RB-Set, a parameter

$${M}_{PRB , set}^{PSFCH}$$

may represent the number of resources in the sl-PSFCH-RB-Set. In some aspects, a number of PSSCH slots corresponding to the PSFCH slot may be represented by a parameter

$${N}_{PSSCH}^{PSFCH} .$$

In some aspects, each subchannel/slot may have a number of PRBs represented by

$${M}_{subch , slot}^{PSFCH} = \frac{{M}_{PRB , set}^{PSFCH}}{{N}_{PSSCH}^{PSFCH} \times {N}_{subch}} .$$

The parameter N_{subch} may represent a number of subchannels. In some aspects, time first mapping may be used from a PSSCH resource to PSFCH PRBs. A PSFCH resource pool size may be represented by

$${R}_{PRB , CS}^{PSFCH}$$

which may be equal to

$${N}_{type}^{PSFCH} \times {N}_{CS}^{PSFCH} \times {M}_{subch , slot}^{PSFCH} .$$

The parameter

$${N}_{CS}^{PSFCH}$$

is the number of CS pairs configured per resource pool (the pair may be for A/N, 1 bit). The parameter

$${N}_{type}^{PSFCH}$$

is 1 or

$${N}_{subch}^{PSSCH} ,$$

for the subchannels in a PSSCH slot, the PSFCH resource pool may be shared or not. Within the pool, the PSFCH resource may be indexed from a PRB index first, and then in CS pair index. A PSFCH resource may be determined from the pool based on the PSFCH resource pool size represented by

$${R}_{PRB , CS}^{PSFCH}$$

and a physical source identifier (ID) P_{ID} from a second stage sidelink control information (SCI) for PSSCH and an M_{ID}, which may represent an identity of the UE receiving the PSSCH or 0. In some aspects, a PSFCH resource determination may be based on

$$( {P}_{ID} + {M}_{ID} ) mod {R}_{PRB , CS}^{PSFCH} .$$

In some examples, for unicast or a NACK (representing data error) based transmission, M_{ID}=0 and the UE may send an A/N or NACK at a source ID dependent resource in the pool.

In some examples, due to power spectral density (PSD) specifications, a maximum power for 20 MHz in SL-U LPI mode and VLP mode may not be reached. For example, for the LPI mode in a 6 GHz band, the PSD specification may be −1 dBm per MHz for the UE and a maximum EIRP may be 24 dBm. As a result, the UE may transmit 320 MHz to reach the peak power, which may not be possible. Similarly, for a VLP mode in the 6 GHz band, the PSD specification may be −18 dBm ˜−8 dBm per MHz for UE and a maximum EIRP may be 4 dBm ˜ 14 dBm. As a result, the UE may transmit 160 MHz to reach the peak power, which may not be possible. As a result of not reaching the peak power, the signal strength and the success rate for the PSFCH transmission in a 6 GHz frequency may suffer. Aspects provided herein may provide better signal strengths and success rates for PSFCH transmissions. In some aspects, a UE may employ PSFCH repetition in the time domain. In some aspects, a UE may employ PSFCH repetition in the frequency domain. In some aspects, the UE may transmit a PSFCH that spans from one RB to multiple RBs.

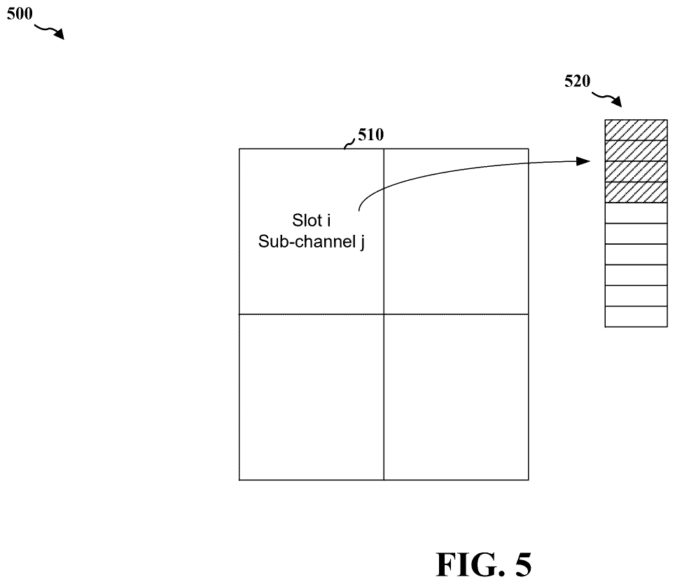

FIG. 5 is an example 500 of assigning PSFCH resources in sidelink communication. The example 500 may include a first set of PRBs 510 for the PSSCH and a second set of PRBs 520 assigned for the PSFCH and illustrate how the first wireless device may select the PRB among the second set of PRBs 520 for transmitting the PSFCH carrying the verification bits. The mapping between the PSSCH and the PSFCH may be based on at least one of 1) the starting sub-channel of the PSSCH, 2) the slot containing the PSSCH, 3) the source ID, or 4) the destination ID. In a case of a groupcast with a group of UEs including one UE acting as a transmission (Tx) UE and the rest of UEs acting as reception (Rx) UEs, option 2 may support the ACK/NACK feedback from all Rx UEs, and therefore, the number of available PSFCH resource may be configured greater than or equal to the number of UEs in the groupcast.

In one aspect, the NR sidelink (SL) and/or LTE vehicle-to-everything (V2X), which may be referred to herein as sidelink communication may be exchanged in the licensed band. Sidelink communication may be based on different types or modes of resource allocation mechanisms. In a first resource allocation mode (which may be referred to herein as “Mode 1”), centralized resource allocation may be provided by a network entity. For example, a base station may determine resources for sidelink communication and may allocate resources to different UEs to use for sidelink transmissions. In the first mode, a UE may receive the allocation of sidelink resources from the base station. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices.

In the second mode (i.e., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

The NR may allow configuring wider carriers in frequency domain (e.g., up to 100 MHz with 30 kHz SCS), a SL on unlicensed bands (SL-U) may be configured with the wideband operation, which may refer to a carrier consisting of multiple LBT bandwidths. For example, the wideband may be configured as 20 MHz in the 5 GHz/6 GHz unlicensed band.

In one aspect, in the SL-U in Mode 1, the network node may issue a grant including a considerable number of sub-channels across multiple RB sets based on the Tx UE reporting a long eMBB-like burst. In this case the Tx UE fails the LBT in some of the RB sets (e.g., at least a part of the RB sets), Tx UE may not perform the transmission in all of the scheduled RB sets.

In another aspect, in the SL-U in mode 2, the Tx UE may monitor the time-frequency resources to reserve the time-frequency resources for SL transmission. Based on the LBT outcome after the waveform generation, the Tx UE may follow different policies to improve the SL data transmission according to the LBT outcome. Furthermore, for the SL-U, the Rx UE may fail the LBT before the PSFCH transmission. Accordingly, some implementation may be configured to support transmission of a PSSCH and a PSFCH based on a partial LBT success and/or failure in the SL-U.

In some aspects, the UE may be configured with a plurality of LBT bandwidths of a PSSCH, and the UE may perform the LBT for each of the LBT bandwidths before transmitting the PSSCH.

In one aspect, the plurality of LBT bandwidths may be available for transmission of the PSSCH. That is, the UE may measure each of the plurality of LBT bandwidths of the PSSCH and the measurement of the plurality of LBT bandwidths of the PSSCH may be less than or equal to a threshold value. Based on the measurement of the plurality of LBT bandwidths of the PSSCH being less than or equal to a threshold value, the UE may reserve the plurality of LBT bandwidths and transmit the PSSCH in the plurality of LBT bandwidths.

In other aspects, at least one LBT bandwidth of the plurality of LBT bandwidths may not be available for transmission of the PSSCH. That is, the UE may measure each of the plurality of LBT bandwidths of the PSSCH and a first measurement of a first LBT bandwidth of the plurality of LBT bandwidths of the PSSCH may be greater than the threshold value. In case the at least one LBT bandwidth of the plurality of LBT bandwidths may not be available for transmission of the PSSCH, the UE may be configured with various policies that may be implemented to address the situation.

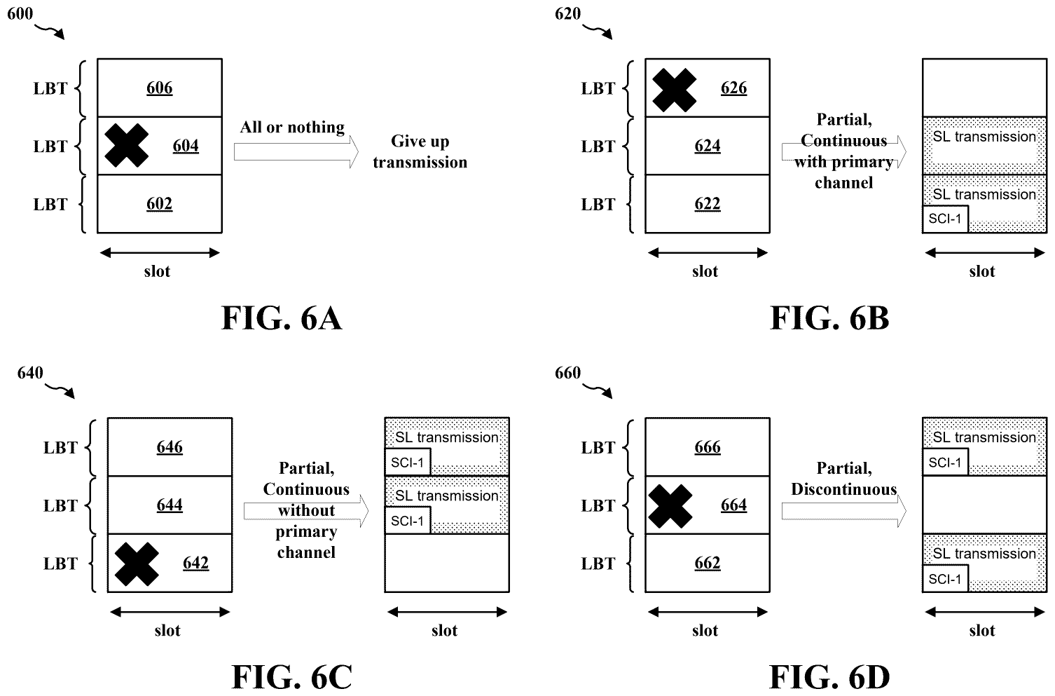

FIGS. 6A, 6B, 6C, and 6D are diagrams 600, 620, 640, and 660, respectively, of various PSSCH transmission policies. FIG. 6A is a diagram 600 illustrating a first PSSCH transmission policy of all-or-nothing. Here, the all-or-nothing transmission may refer to refraining from transmitting the PSSCH in the plurality of LBT bandwidths based on finding a single LBT failure. That is, based on the UE obtaining an indication that the first measurement of the first LBT bandwidth of the plurality of LBT bandwidths of the PSSCH is greater than the threshold value, the UE may determine not to transmit the PSSCH in the plurality of LBT bandwidths.

For example, the plurality of LBT bandwidths includes a third LBT bandwidth 606, a second LBT bandwidth 604, and a first LBT bandwidth 602, and the second LBT bandwidth 604 may not be available for PSSCH transmission. Under the first PSSCH transmission policy of all-or-nothing, the UE may determine not to transmit the PSSCH in the plurality of LBT bandwidths.

FIG. 6B is a diagram 620 illustrating a second PSSCH transmission policy of a partial transmission for continuous LBT bandwidths with the primary channel. The primary channel may refer to the RB set with a SL control information (SCI) format 1 (SCI-1) transmission. The SCI-1 may configured to be located in the lowest sub-channel occupied by the associated PSCCH. Here, the plurality of LBT bandwidths other than the first LBT bandwidth of the PSSCH may include a plurality of LBT bandwidths continuously configured in a frequency domain and the plurality of LBT bandwidths continuously configured in the frequency domain may include the primary channel. The UE may be configured to transmit the PSSCH on the successful LBT bandwidths that are continuous and include the primary channel.

For example, the plurality of LBT bandwidths includes a third LBT bandwidth 626, a second LBT bandwidth 624, and a first LBT bandwidth 622, and the third LBT bandwidth 626 may not be available for PSSCH transmission, and the second LBT bandwidth 624 and the first LBT bandwidth 622 that are available for PSSCH transmission may be continuously configured, and the first LBT bandwidth 622 may include the primary channel. Under the second PSSCH transmission policy, the UE may transmit the PSSCH in the second LBT bandwidth 624 and the first LBT bandwidth 622 that are available for PSSCH transmission, and the first LBT bandwidth 622 may include the SCI-1.

FIG. 6C is a diagram 640 illustrating a third PSSCH transmission policy of a partial transmission for continuous LBT bandwidths without the primary channel. Here, the plurality of LBT bandwidths other than the first LBT bandwidth of the PSSCH may include a plurality of LBT bandwidths continuously configured in a frequency domain and the plurality of LBT bandwidths continuously configured in the frequency domain may not include the primary channel. The UE may be configured to transmit the PSSCH on the successful LBT bandwidths that are continuous and not include the primary channel. Because the successful LBT bandwidths that are continuous do not include the primary channel, the UE may transmit repetitions of the SCI-1 in each of the successful LBT bandwidths. Therefore, the UE may support SCI-1 repetition to support the third PSSCH transmission policy of the partial transmission for continuous LBT bandwidths without the primary channel.

For example, the plurality of LBT bandwidths includes a third LBT bandwidth 646, a second LBT bandwidth 644, and a first LBT bandwidth 642, and the first LBT bandwidth 642 may not be available for PSSCH transmission, and the third LBT bandwidth 646 and the second LBT bandwidth 644 that are available for PSSCH transmission may be continuously configured, and the third LBT bandwidth 646 and the second LBT bandwidth 644 may not include the primary channel. Under the third PSSCH transmission policy, the UE may transmit the PSSCH in the third LBT bandwidth 646 and the second LBT bandwidth 644 that are available for PSSCH transmission, and each of the third LBT bandwidth 646 and the second LBT bandwidth 644 may include a repetition of SCI-1.

FIG. 6D is a diagram 660 illustrating a fourth PSSCH transmission policy of a partial transmission for discontinuous LBT bandwidths. Here, the plurality of LBT bandwidths other than the first LBT bandwidth of the PSSCH may include a plurality of LBT bandwidths discontinuously configured in a frequency domain and the plurality of LBT bandwidths discontinuously configured in the frequency domain. The UE may be configured to transmit the PSSCH on the successful LBT bandwidths that are discontinuous. The UE may transmit the SCI-1 in the LBT bandwidth and also transmit a repetition of the SCI-1 in the discontinuous LBT bandwidth. Therefore, the UE may support SCI-1 repetition to support the fourth PSSCH transmission policy of the partial transmission for discontinuous LBT bandwidths.

For example, the plurality of LBT bandwidths includes a third LBT bandwidth 666, a second LBT bandwidth 664, and a first LBT bandwidth 662, and the second LBT bandwidth 664 may not be available for PSSCH transmission, and the third LBT bandwidth 666 and the first LBT bandwidth 662 that are available for PSSCH transmission may be discontinuously configured, and the third LBT bandwidth 666 may include the primary channel. Under the fourth PSSCH transmission policy, the UE may transmit the PSSCH in the third LBT bandwidth 666 and the first LBT bandwidth 662 that are available for PSSCH transmission, and the first LBT bandwidth 662 may include the SCI-1 and the third LBT bandwidth 666 may include the repetition of the SCI-1.

In some aspects, the UE's behavior for transmitting PSSCH may be controlled via an RRC parameter received from the network node. That is, the network node may transmit the RRC parameter to the Tx UE, and the Tx UE may decide which policy to follow to transmit the PSSCH in case the at least one LBT bandwidth of the plurality of LBT bandwidths may not be available for transmission of the PSSCH.

In one aspect, the SL UE may report its capability or suitable/desired policy to the network node, and the network node may use the RRC parameter to indicate which policy the SL UE should use or apply. Here, the capability of the UE may include a first capability of the UE to prepare a waveform corresponding to the at least one RB set associated with the plurality of LBT bandwidths, a second capability of the UE to support SL control information SCI-1 repetition, etc., and the UE indication may include a power consumption level of the UE.

In one example, the UE may make the decision based on the first capability of the UE to prepare a waveform corresponding to the at least one RB set associated with the plurality of LBT bandwidths. That is, to support the second PSSCH transmission policy, the third PSSCH transmission policy, or the fourth PSSCH transmission policy, the UE may need to prepare a waveform corresponding to the RB sets associated with the plurality of LBT bandwidths. The UE may use the default waveform for the overall plurality of LBT bandwidths when the UE follows the first PSSCH transmission policy of all-or-nothing transmission.

In another example, the UE may make a decision based on whether SCI-1 repetitions are supported. That is, based on the second capability of the UE to support SL control information SCI-1 repetition, the UE may determine the proper PSSCH transmission policy. Because the repetition of the SCI-1 is included in the third PSSCH transmission policy and the fourth PSSCH transmission policy, the UE with the second capability of the UE to support SL control information SCI-1 repetition may support the third PSSCH transmission policy and the fourth PSSCH transmission policy, and the UE without the second capability of the UE to support SL control information SCI-1 repetition may not support or follow the third PSSCH transmission policy and the fourth PSSCH transmission policy.

In another example, the UE may make the decision based on the power consumption. The UE may have an increased power consumption to prepare waveforms for different PSSCH transmission policies. Accordingly, the RRC parameter may provide a power consumption level of the UE, and the UE may determine not to implement certain PSSCH transmission policy based on the power consumption level being less than a power threshold value.

In another aspect, the network node may configure the network resources based on the RRC parameter associated with the PSSCH transmission policy. For example, the network node may allocate a reduced number of RB sets and an increased number of slots to UEs implemented with the first PSSCH transmission policy of the all-or-nothing transmission.

In some aspects, the SCI-1 may provide a frequency domain resource allocation (FDRA) indicating the RB set used for the PSSCH transmission. In case the UE following the first PSSCH transmission policy of all-or-nothing transmission and the second and the third PSSCH transmission policies of partial transmission in the continuous LBT bandwidths, the UE may use the FDRA format that indicates a number of slots and a number of sub-channels reserved for the reserved resources associated with the transmission of the PSSCH. In case of the UE following the fourth PSSCH transmission policy of partial transmission in the discontinuous LBT bandwidths, the UE may use a dedicated FDRA format may be used. In one example, the dedicated FDRA may include a plurality of FDRAs, each indicating the number of slots and the number of sub-channels for a corresponding RB set. In another example, the dedicated FDRA may include a bitmap indicating the RB sets associated with the LBT bandwidths for transmitting the PSSCH.

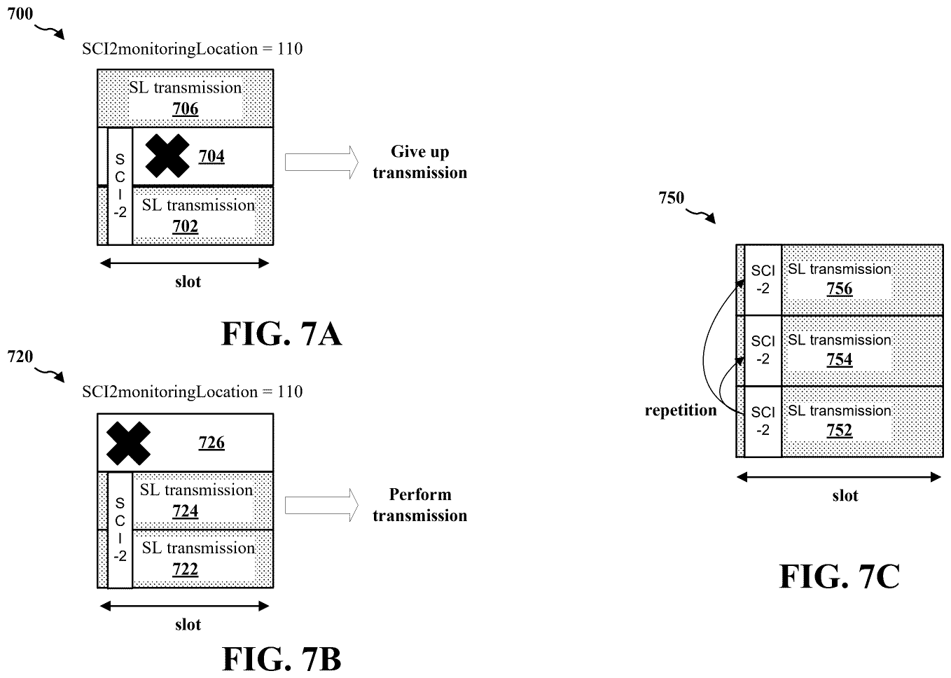

FIGS. 7A, 7B, and 7C are diagrams 700, 720, and 750, respectively, of PSSCH transmissions based on mapping of an SCI format 2 (SCI-2) transmission. The transmission of the PSSCH may be based on the SCI-2 transmission. In one aspect, the SCI-2 may be mapped to a contiguous RBs in the PSSCH starting from the first symbol with the PSSCH DMRS. If the PSSCH transmission policy of partial transmission in the discontinuous LBT bandwidths is implemented, the RB sets associated with the discontinuous LBT bandwidths may have puncturing, and the SCI-2 may not be properly mapped because the SCI-2 mapping is first performed in the frequency domain.

In one aspect, the SL Tx UE may determine the mappable RB sets for SCI-2. That is, to support the transmission of the SCI-2, the Tx SL UE may determine whether the SCI-2 may be mapped to the RB sets associated with the at least one LBT bandwidth. Based on determining that the SCI-2 may not be mappable to the RB sets associated with the at least one LBT bandwidth, the SL Tx UE may determine to refrain from (e.g., skip or postpone) transmitting the PSSCH. The SL Tx UE may indicate the mappable RB sets for the SCI-2 to the SL Rx UE via a PC-5 RRC parameter (e.g., SCI2MonitoringLocation).

FIG. 7A illustrates a diagram 700 illustrating a partial transmission with a single SCI-2. Here, the second LBT bandwidth 704 may not be available for transmitting the PSSCH, so the PSSCH may be transmitted in the third LBT bandwidth 706 and the first LBT bandwidth 702 that are discontinuously configured. Since the SCI-2 has the frequency range of two LBT bandwidth, the SCI-2 may not be properly mapped to the third LBT bandwidth 706 and the first LBT bandwidth 702 that are discontinuously configured. Therefore, the SL Tx UE may refrain from transmitting the PSSCH in the RB set associated with the third LBT bandwidth 706 and the first LBT bandwidth 702 that are discontinuously configured.

FIG. 7B is a diagram 720 illustrating a partial transmission for discontinuous LBT bandwidths. Here, the third LBT bandwidth 726 may not be available for transmitting the PSSCH, so the PSSCH may be transmitted in the first LBT bandwidth 722 and the second LBT bandwidth 724 that are continuously configured. Because the SCI-2 with the frequency range of two LBT bandwidth may be properly mapped to the first LBT bandwidth 722 and the second LBT bandwidth 724 that are continuously configured, the SL Tx UE may transmit the PSSCH in the RB set associated with the first LBT bandwidth 722 and the second LBT bandwidth 724 that are continuously configured.

In another aspect, the SL Tx UE with a SCI-2 with a distributed design for the wideband operation. That is, the SCI-2 may be mapped within one RB set, and images of SCI-2 may repeatedly transmitted in other RB sets. FIG. 7C is a diagram 750 illustrating mapping the SCI-2 with the distributed design. The SCI-2 may have the frequency range of a single LBT bandwidth, the SCI-2 may be properly mapped into the first RB set associated with the first LBT bandwidth 752. Furthermore, the SCI-2 may be repeatedly transmitted in the second RB set associated with the second LBT bandwidth 754 and the third RB set associated with the third LBT bandwidth 756.

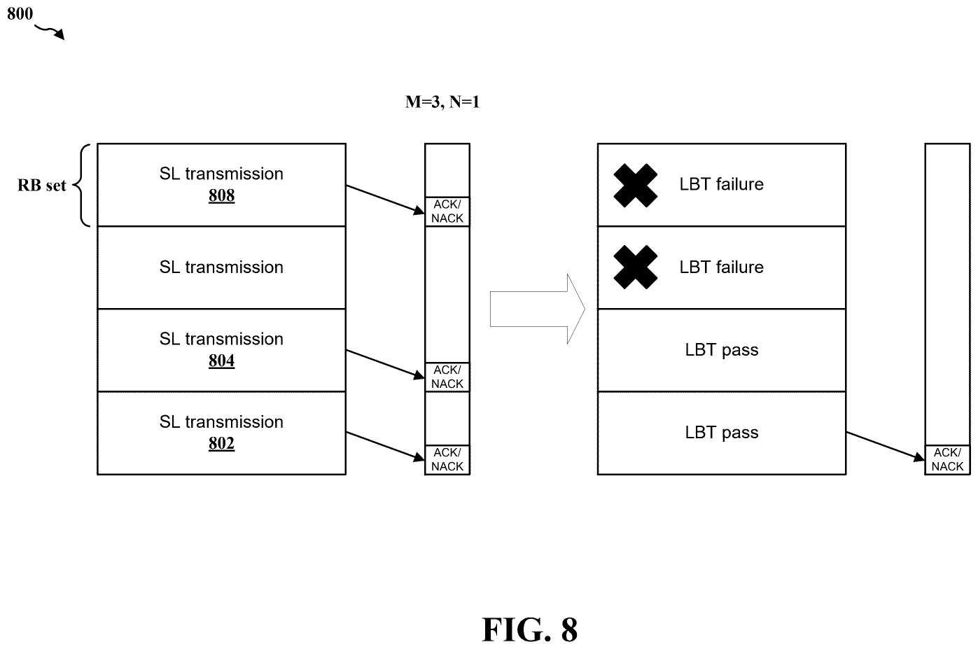

FIG. 8 is a diagram 800 of PSSCH to PSFCH mapping. In some aspects, the PSSCH to PSFCH mapping may be configured with a plurality of images of the PSFCH. In one aspect, a HARQ feedback for a given PSSCH transmission may be transmitted in one PRB of the PSFCH symbol. The transmission of the PSFCH may also be conditional to the LBT, and if the LBT fails and the corresponding RB-set is not available for sidelink transmission, the SL Rx UE may not transmit the PSFCH to the SL Tx UE. In order to reduce the LBT failure, a PSSCH to PSFCH mapping with multiple images of the PSFCH may be configured.

In one aspect, the PSSCH to PSFCH mapping may be based on the starting sub-channel of each RB-set, and the number of used RB sets for PSSCH to PSFCH mapping may be configured by the network node, e.g., M. The network node may increase the number of the RB sets used to improve the reliability. But increased number of the used RB sets may lead to increased probability of the UE collision.

In another aspect, the number of the transmitted PRBs in the PSFCH symbol may be configured by the network node, e.g., N. The network node may increase the number of the PRBs used in the PSFCH to improve the reliability. But increased number of the PRBs used in the PSFCH may lead to increased probability of UE collision.

The diagram 800 shows that network node configured that three (3) RB sets for the PSSCH are mapped to the PSFCH, and that each PSFCH may include one (1) PRB. Here, based on the network node's configuration that three (3) RB sets are mapped to the PSFCH, a first RB set 802 with a first LBT bandwidth, a second RB set 804 with a second LBT bandwidth, and a fourth RB set 808 associated with a fourth LBT bandwidth. Since the third and fourth LBT bandwidths are not available to transmit the PSSCH, the PSFCH mapped to the first RB set 802 associated with a first LBT bandwidth and the second RB set 804 associated with the second LBT bandwidth. Because the network also configured that one PRB may be used by the feedback. Accordingly, among the two PRBs, the Rx SL UE may select the PRB associated or mapped with the first RB set 802 associated with the first LBT bandwidth may be used to transmit the PSFCH.

In some aspects, the network node may receive a message from a SL Rx UE and determine the number of used RB sets and the number of transmitted PRBs based on the message from the SL Rx UE. The SL Rx UE may report the message to the network node to help the network node determine the number of used RB sets and the number of transmitted PRBs. The network node may indicate the number of used RB sets and the number of transmitted PRBs to the UEs including the SL Tx UE and the SL Rx UE via the RRC parameter.

The message transmitted by the SL Rx UE may include at least one of channel busy ratio (CBR), LBT success rate before the PSFCH, inter radio access technology (inter-RAT) received signal strength indicator (RSSI), or any combination of above options. Here the LBT success rate may be inferred or obtained by counting the successful LBT attempts made for PSFCH transmission in the past t-seconds.

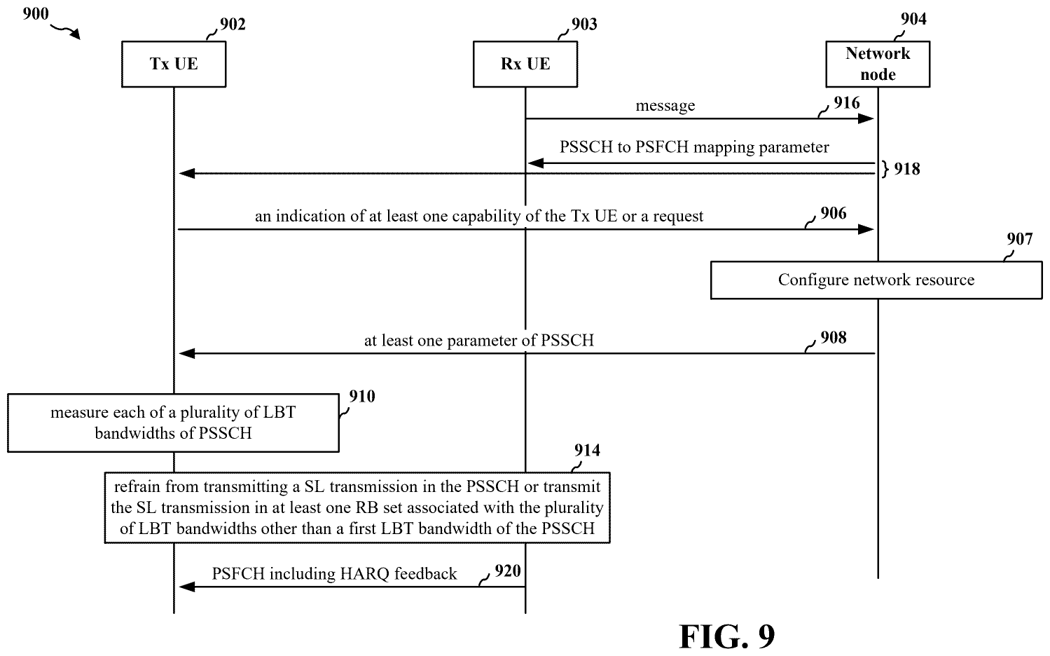

FIG. 9 is a call-flow diagram 900 of a method of wireless communication. The call-flow diagram 900 may include a Tx UE 902, a Rx UE 903, and a network node 904. The Tx UE 902 may be configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value.

At 916, the network node 904 may receive a message from the Rx UE 903, the at least one parameter of the PSFCH being associated with the message. Here, the at least one parameter may be associated with at least one metric at the Rx UE 903, the at least one metric including a CBR, a LBT success rate before the PSFCH, or an inter-RAT RSSI.

At 918, the network node 904 may transmit at least one parameter of a PSFCH for the Tx UE 902 and/or the Rx UE 903. The Tx UE 902 may receive at least one parameter of a PSFCH. Here, the at least one parameter of a PSFCH may refer to a parameter may refer to a PSSCH to PSFCH mapping parameter. Here, the at least one parameter of the PSFCH may be indicated to the Rx UE 903 to transmit the PSFCH including a HARQ feedback of the PSSCH based on the PSSCH to PSFCH mapping parameter.

At 906, the Tx UE 902 may transmit an indication of at least one capability of the Tx UE 902 to the network node 904 or a request to refrain from transmitting the SL transmission in the PSSCH or transmit the SL transmission in at least one RB set associated with the plurality of LBT bandwidths other than the first LBT bandwidth of the PSSCH. The network node 904 may receive an indication of at least one capability of a Tx UE 902 or a request from the Tx UE 902. Here, the at least one parameter at 908 may be associated with the at least one capability of the Tx UE 902 or the request transmitted to the network node 904.

At 907, the network node 904 may configure at least one network resource for the Tx UE 902, the at least one network resource is associated with the at least one parameter of PSSCH. For example, the network node 904 may allocate a reduced number of RB sets and an increased number of slots to the Tx UE 902 implemented with the first PSSCH transmission policy of the all-or-nothing transmission. Here, the at least one parameter of the PSSCH may be indicated to the Tx UE 902 to transmit the SL transmission in the at least one RB set associated with the plurality of LBT bandwidths other than the first LBT bandwidth of the PSSCH, and the Rx UE 903 to receive the SL transmission in the at least one RB set associated with the plurality of LBT bandwidths other than the first LBT bandwidth of the PSSCH.

At 908, the network node 904 may transmit at least one parameter for the Tx UE 902 based at least in part on receiving the indication of the at least one capability of the Tx UE 902 or the request from the Tx UE 902. The Tx UE 902 may receive at least one parameter from a network node 904, where the at least one parameter indicates to the Tx UE 902 to transmit the SL transmission in the at least one RB set associated with the plurality of LBT bandwidths other than the first LBT bandwidth of the PSSCH.

At 910, the Tx UE 902 may measure each of a plurality of LBT bandwidths of a PSSCH. Here, the Tx UE 902 may be performing the LBT to transmit the PSSCH.

At 914, the Tx UE 902 may refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. Here, the first LBT bandwidth may be at least one failed LBT bandwidth that corresponds to the first measurement of the first LBT bandwidth being greater than the threshold value.

In one aspect, the at least one RB set associated with the plurality of LBT bandwidths other than the first LBT bandwidth of the PSSCH may include a plurality of LBT bandwidths continuously configured in a frequency domain, and the SL transmission may be transmitted in the plurality of LBT bandwidths continuously configured in the frequency domain. In one example, the plurality of LBT bandwidths continuously configured in the frequency domain may include a primary channel including SCI-1. In another example, the plurality of LBT bandwidths continuously configured in the frequency domain may not include a primary channel, and each LBT bandwidth of the plurality of LBT bandwidths may include SCI-1. In another example, the at least one RB set associated with the plurality of LBT bandwidths may include a plurality of LBT bandwidths discontinued in a frequency domain by the first LBT bandwidth, and each LBT bandwidth of the plurality of LBT bandwidths may include SCI-1.

In another aspect, the at least one parameter at 908 may be associated with a first capability of the Tx UE 902 to prepare a waveform corresponding to the at least one RB set associated with the plurality of LBT bandwidths other than the first LBT bandwidth of the PSSCH. In one example, the SL transmission may be transmitted in the at least one RB set associated with the plurality of LBT bandwidths other than the first LBT bandwidth of the PSSCH based on the Tx UE 902 having the first capability to prepare the waveform corresponding to the at least one RB set associated with the plurality of LBT bandwidths other than the first LBT bandwidth of the PSSCH.

In another aspect, the at least one parameter may be associated with a second capability of the Tx UE 902 to support SCI-1 repetition. In one example, the SL transmission may be transmitted in the at least one RB set associated with the plurality of LBT bandwidths including a plurality of LBT bandwidths continuously configured in a frequency domain and the plurality of LBT bandwidths including a primary channel, and the SL transmission may be transmitted based on the Tx UE 902 not having the second capability to support the SCI-1 repetition. In another example, the SL transmission may be transmitted in the at least one RB set associated with the plurality of LBT bandwidths including a plurality of LBT bandwidths continuously configured in a frequency domain and the plurality of LBT bandwidths not including a primary channel, where the SL transmission may be transmitted based on the Tx UE 902 having the second capability to support the SCI-1 repetition, and each LBT bandwidth of the plurality of LBT bandwidths may include the SCI-1 repetition. In another example, the SL transmission may be transmitted in the at least one RB set associated with the plurality of LBT bandwidths including a plurality of LBT bandwidths not continuously configured in a frequency domain based on the Tx UE 902 having the second capability to support the SCI-1 repetition, and each LBT bandwidth of the plurality of LBT bandwidths may include the SCI-1 repetition. In another example, the SL transmission may not be transmitted in the at least one RB set associated with the plurality of LBT bandwidths including a plurality of LBT bandwidths not continuously configured in a frequency domain or the plurality of LBT bandwidths not including a primary channel, and the SL transmission may be transmitted based on the Tx UE 902 not having the second capability to support the SCI-1 repetition.

In another aspect, the at least one parameter may be associated with a power consumption of the Tx UE 902, and the SL transmission may not be transmitted in the at least one RB set associated with the plurality of LBT bandwidths other than the first LBT bandwidth of the PSSCH based on the power consumption of the Tx UE 902 being configured lower than a power threshold value.

In another aspect, the SL transmission transmitted in the at least one RB set associated with the plurality of LBT bandwidths other than the first LBT bandwidth of the PSSCH may include a SCI-1, and the SCI-1 may include an indication of the at least one RB set associated with the plurality of LBT bandwidths other than the first LBT bandwidth of the PSSCH. Here, the SCI-1 may include a bitmap indicating the at least one RB set associated with the plurality of LBT bandwidths other than the first LBT bandwidth of the PSSCH.

In another aspect, the SL transmission may include a SCI-2 mapped to multiple RB sets starting from a primary channel. In one example, the SL transmission may be transmitted in the at least one RB set associated with the plurality of LBT bandwidths including a plurality of LBT bandwidths continuously configured in a frequency domain, and the SL transmission may be transmitted based on the SCI-2 being mappable within the plurality of LBT bandwidths continuously configured in the frequency domain. In another example, the SL transmission may include a SCI-2 mapped to a single RB set in a primary channel, and the SCI-2 may be repeated in each LBT bandwidth of the plurality of LBT bandwidths.

At 920, the Rx UE 903 may transmit the PSFCH including a HARQ feedback from a Rx UE 903. The Tx UE 902 may receive the PSFCH including a HARQ feedback from a Rx UE 903. Here, the PSFCH may be associated with the PSSCH to PSFCH mapping parameter received at 918.

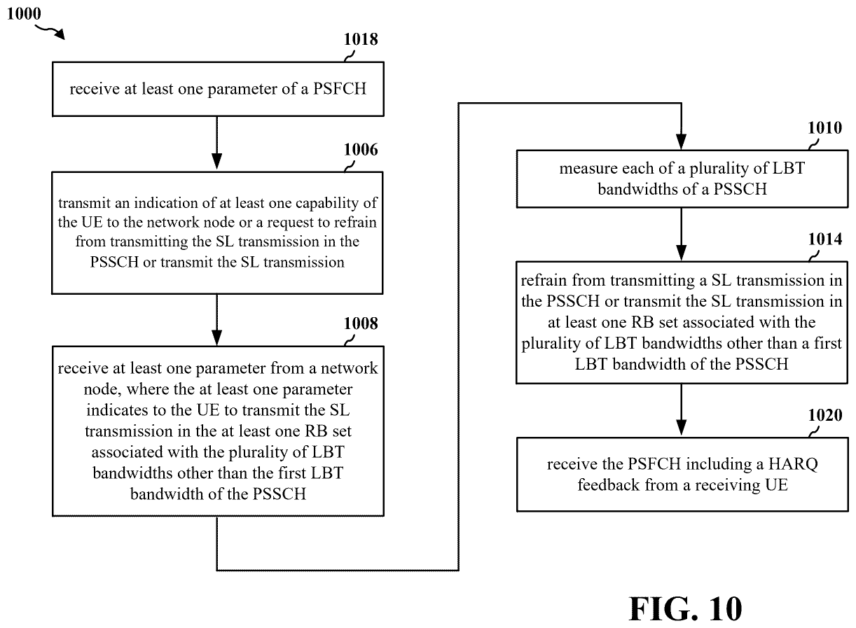

FIG. 10 is a flowchart 1000 of a method of wireless communication. The method may be performed by a UE (e.g., the UE 104; the Tx UE 902; the apparatus 1604). The UE may be a TX UE configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value.

At 1018, the UE may receive at least one parameter of a PSFCH. Here, the at least one parameter of a PSFCH may refer to a parameter may refer to a PSSCH to PSFCH mapping parameter. Here, the at least one parameter may indicate to the UE to transmit the SL transmission in the at least one RB set associated with the plurality of LBT bandwidths other than the first LBT bandwidth of the PSSCH. The UE may receive the PSFCH including a HARQ feedback from a Rx UE. For example, at 918, the Tx UE 902 may receive at least one parameter of a PSFCH. Furthermore, 1018 may be performed by the SL component 198.

At 1006, the UE may transmit an indication of at least one capability of the UE to the network node or a request to refrain from transmitting the SL transmission in the PSSCH or transmit the SL transmission in at least one RB set associated with the plurality of LBT bandwidths other than the first LBT bandwidth of the PSSCH. Here, the at least one parameter at 1008 may be associated with the at least one capability of the UE or the request transmitted to the network node. For example, at 906, the Tx UE 902 may transmit an indication of at least one capability of the Tx UE 902 to the network node 904 or a request to refrain from transmitting the SL transmission in the PSSCH or transmit the SL transmission in at least one RB set associated with the plurality of LBT bandwidths other than the first LBT bandwidth of the PSSCH. Furthermore, 1006 may be performed by a SL component 198.

At 1008, the UE may receive at least one parameter from a network node, where the at least one parameter indicates to the UE to transmit the SL transmission in the at least one RB set associated with the plurality of LBT bandwidths other than the first LBT bandwidth of the PSSCH. at least one parameter for the UE based at least in part on receiving the indication of the at least one capability of the UE or the request from the UE. For example, at 908, the Tx UE 902 may receive at least one parameter from a network node 904, where the at least one parameter indicates to the Tx UE 902 to transmit the SL transmission in the at least one RB set associated with the plurality of LBT bandwidths other than the first LBT bandwidth of the PSSCH. Furthermore, 1008 may be performed by the SL component 198.

At 1010, the UE may measure each of a plurality of LBT bandwidths of a PSSCH. Here, the UE may be performing the LBT to transmit the PSSCH. For example, at 910, the Tx UE 902 may measure each of a plurality of LBT bandwidths of a PSSCH. Furthermore, 1010 may be performed by the SL component 198.

At 1014, the UE may refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. Here, the first LBT bandwidth may be at least one failed LBT bandwidth that corresponds to the first measurement of the first LBT bandwidth being greater than the threshold value. For example, at 914, the Tx UE 902 may refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. Furthermore, 1014 may be performed by the SL component 198.

In one aspect, the at least one RB set associated with the plurality of LBT bandwidths other than the first LBT bandwidth of the PSSCH may include a plurality of LBT bandwidths continuously configured in a frequency domain, and the SL transmission may be transmitted in the plurality of LBT bandwidths continuously configured in the frequency domain. In one example, the plurality of LBT bandwidths continuously configured in the frequency domain may include a primary channel including SCI-1. In another example, the plurality of LBT bandwidths continuously configured in the frequency domain may not include a primary channel, and each LBT bandwidth of the plurality of LBT bandwidths may include SCI-1. In another example, the plurality of LBT bandwidths continuously configured in the frequency domain may not include a primary channel, and each LBT bandwidth of the plurality of LBT bandwidths may include SCI-1. In another example, the at least one RB set associated with the plurality of LBT bandwidths may include a plurality of LBT bandwidths discontinued in a frequency domain by the first LBT bandwidth, and each LBT bandwidth of the plurality of LBT bandwidths may include SCI-1.

In another aspect, the at least one parameter at 1008 may be associated with a first capability of the UE to prepare a waveform corresponding to the at least one RB set associated with the plurality of LBT bandwidths other than the first LBT bandwidth of the PSSCH. In one example, the SL transmission may be transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH.

In another aspect, the at least one parameter may be associated with a second capability of the UE to support SCI-1 repetition. In one example, the SL transmission may be transmitted in the at least one RB set associated with the plurality of LBT bandwidths including a plurality of LBT bandwidths continuously configured in a frequency domain and the plurality of LBT bandwidths including a primary channel, and the SL transmission may be transmitted based on the UE not having the second capability to support the SCI-1 repetition. In another example, the SL transmission may be transmitted in the at least one RB set associated with the plurality of LBT bandwidths including a plurality of LBT bandwidths continuously configured in a frequency domain and the plurality of LBT bandwidths not including a primary channel, where the SL transmission may be transmitted based on the UE having the second capability to support the SCI-1 repetition, and each LBT bandwidth of the plurality of LBT bandwidths may include the SCI-1 repetition. In another example, the SL transmission may be transmitted in the at least one RB set associated with the plurality of LBT bandwidths including a plurality of LBT bandwidths not continuously configured in a frequency domain based on the UE having the second capability to support the SCI-1 repetition, and each LBT bandwidth of the plurality of LBT bandwidths may include the SCI-1 repetition. In another example, the SL transmission may not be transmitted in the at least one RB set associated with the plurality of LBT bandwidths including a plurality of LBT bandwidths not continuously configured in a frequency domain or the plurality of LBT bandwidths not including a primary channel, and the SL transmission may be transmitted based on the UE not having the second capability to support the SCI-1 repetition.

In another aspect, the at least one parameter may be associated with a power consumption of the UE, and the SL transmission may not be transmitted in the at least one RB set associated with the plurality of LBT bandwidths other than the first LBT bandwidth of the PSSCH based on the power consumption of the UE being configured lower than a power threshold value.

In another aspect, the SL transmission transmitted in the at least one RB set associated with the plurality of LBT bandwidths other than the first LBT bandwidth of the PSSCH may include a SCI-1, and the SCI-1 may include an indication of the at least one RB set associated with the plurality of LBT bandwidths other than the first LBT bandwidth of the PSSCH. Here, the SCI-1 may include a bitmap indicating the at least one RB set associated with the plurality of LBT bandwidths other than the first LBT bandwidth of the PSSCH.

In another aspect, the SL transmission may include a SCI-2 mapped to multiple RB sets starting from a primary channel. In one example, the SL transmission may be transmitted in the at least one RB set associated with the plurality of LBT bandwidths including a plurality of LBT bandwidths continuously configured in a frequency domain, and the SL transmission may be transmitted based on the SCI-2 being mappable within the plurality of LBT bandwidths continuously configured in the frequency domain. In another example, the SL transmission may include a SCI-2 mapped to a single RB set in a primary channel, and the SCI-2 may be repeated in each LBT bandwidth of the plurality of LBT bandwidths.

At 1020, the UE may transmit the PSFCH including a HARQ feedback from an Rx UE. Here, the PSFCH may be associated with the PSSCH to PSFCH mapping parameter received at 1018. The PSFCH may be transmitted based on the at least one parameter of the PSFCH. The at least one parameter may be associated with at least one metric at the Rx UE, the at least one metric including: a CBR, a LBT success rate before the PSFCH; or an inter-RAT RSSI. For example, at 910, the Tx UE 902 may transmit the PSFCH including a HARQ feedback from a Rx UE 903. Furthermore, 1010 may be performed by the SL component 198.

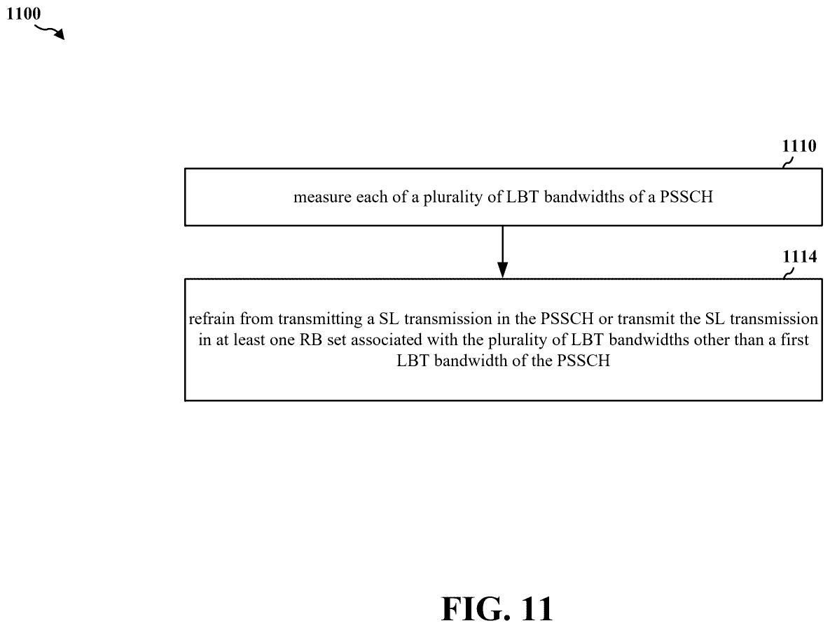

FIG. 11 is a flowchart 1100 of a method of wireless communication. The method may be performed by a UE (e.g., the UE 104; the Tx UE 902; the apparatus 1604). The UE may be configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value.

At 1110, the UE may measure each of a plurality of LBT bandwidths of a PSSCH. Here, the UE may be performing the LBT to transmit the PSSCH. For example, at 910, the Tx UE 902 may measure each of a plurality of LBT bandwidths of a PSSCH. Furthermore, 1110 may be performed by the SL component 198.

At 1114, the UE may refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. Here, the first LBT bandwidth may be at least one failed LBT bandwidth that corresponds to the first measurement of the first LBT bandwidth being greater than the threshold value. For example, at 914, the Tx UE 902 may refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. Furthermore, 1114 may be performed by the SL component 198.

In one aspect, the at least one RB set associated with the plurality of LBT bandwidths other than the first LBT bandwidth of the PSSCH may include a plurality of LBT bandwidths continuously configured in a frequency domain, and the SL transmission may be transmitted in the plurality of LBT bandwidths continuously configured in the frequency domain. In one example, the plurality of LBT bandwidths continuously configured in the frequency domain may include a primary channel including SCI-1. In another example, the plurality of LBT bandwidths continuously configured in the frequency domain may not include a primary channel, and each LBT bandwidth of the plurality of LBT bandwidths may include SCI-1. In another example, the plurality of LBT bandwidths continuously configured in the frequency domain may not include a primary channel, and each LBT bandwidth of the plurality of LBT bandwidths may include SCI-1. In another example, the at least one RB set associated with the plurality of LBT bandwidths may include a plurality of LBT bandwidths discontinued in a frequency domain by the first LBT bandwidth, and each LBT bandwidth of the plurality of LBT bandwidths may include SCI-1.

In another aspect, the at least one parameter at 1108 may be associated with a first capability of the UE to prepare a waveform corresponding to the at least one RB set associated with the plurality of LBT bandwidths other than the first LBT bandwidth of the PSSCH. In one example, the SL transmission may be transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH.

In another aspect, the at least one parameter may be associated with a second capability of the UE to support SCI-1 repetition. In one example, the SL transmission may be transmitted in the at least one RB set associated with the plurality of LBT bandwidths including a plurality of LBT bandwidths continuously configured in a frequency domain and the plurality of LBT bandwidths including a primary channel, and the SL transmission may be transmitted based on the UE not having the second capability to support the SCI-1 repetition. In another example, the SL transmission may be transmitted in the at least one RB set associated with the plurality of LBT bandwidths including a plurality of LBT bandwidths continuously configured in a frequency domain and the plurality of LBT bandwidths not including a primary channel, where the SL transmission may be transmitted based on the UE having the second capability to support the SCI-1 repetition, and each LBT bandwidth of the plurality of LBT bandwidths may include the SCI-1 repetition. In another example, the SL transmission may be transmitted in the at least one RB set associated with the plurality of LBT bandwidths including a plurality of LBT bandwidths not continuously configured in a frequency domain based on the UE having the second capability to support the SCI-1 repetition, and each LBT bandwidth of the plurality of LBT bandwidths may include the SCI-1 repetition. In another example, the SL transmission may not be transmitted in the at least one RB set associated with the plurality of LBT bandwidths including a plurality of LBT bandwidths not continuously configured in a frequency domain or the plurality of LBT bandwidths not including a primary channel, and the SL transmission may be transmitted based on the UE not having the second capability to support the SCI-1 repetition.

In another aspect, the at least one parameter may be associated with a power consumption of the UE, and the SL transmission may not be transmitted in the at least one RB set associated with the plurality of LBT bandwidths other than the first LBT bandwidth of the PSSCH based on the power consumption of the UE being configured lower than a power threshold value.

In another aspect, the SL transmission transmitted in the at least one RB set associated with the plurality of LBT bandwidths other than the first LBT bandwidth of the PSSCH may include a SCI-1, and the SCI-1 may include an indication of the at least one RB set associated with the plurality of LBT bandwidths other than the first LBT bandwidth of the PSSCH. Here, the SCI-1 may include a bitmap indicating the at least one RB set associated with the plurality of LBT bandwidths other than the first LBT bandwidth of the PSSCH.

In another aspect, the SL transmission may include a SCI-2 mapped to multiple RB sets starting from a primary channel. In one example, the SL transmission may be transmitted in the at least one RB set associated with the plurality of LBT bandwidths including a plurality of LBT bandwidths continuously configured in a frequency domain, and the SL transmission may be transmitted based on the SCI-2 being mappable within the plurality of LBT bandwidths continuously configured in the frequency domain. In another example, the SL transmission may include a SCI-2 mapped to a single RB set in a primary channel, and the SCI-2 may be repeated in each LBT bandwidth of the plurality of LBT bandwidths.

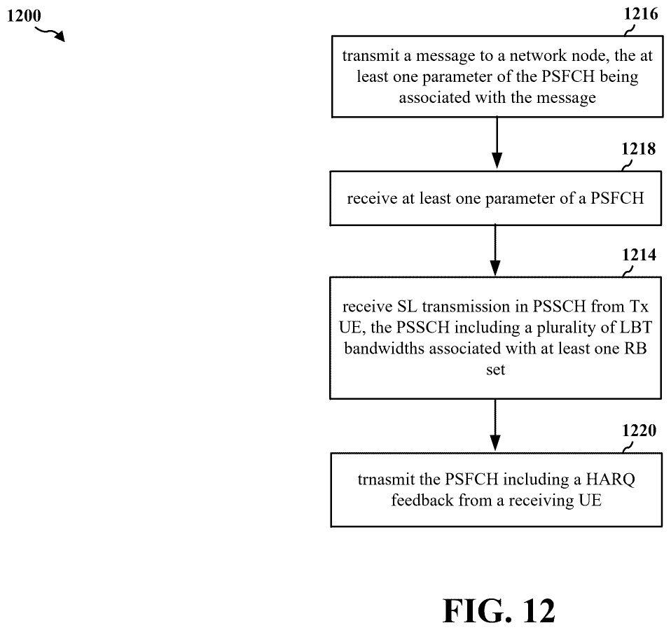

FIG. 12 is a flowchart 1200 of a method of wireless communication. The method may be performed by a UE (e.g., the UE 104; the Rx UE 903; the apparatus 1604). The UE may be a RX UE configured to receive a SL transmission in a PSSCH from a Tx UE, the PSSCH including a plurality of LBT bandwidths associated with at least one RB set, and transmit a PSFCH including a HARQ feedback of the PSSCH, the PSFCH being mapped to a starting sub-channel of each RB set of the plurality of LBTs of the PSSCH.

At 1216, the UE may transmit a message to the network node, the at least one parameter of the PSFCH being associated with the message. Here, the at least one parameter may be associated with at least one metric at the Rx UE, the at least one metric including a CBR, a LBT success rate before the PSFCH, or an inter-RAT RSSI. For example, at 916, the Rx UE 903 may transmit a message to the network node 904, the at least one parameter of the PSFCH being associated with the message. Furthermore, 1216 may be performed by the SL component 198.

At 1218, the UE may receive at least one parameter of the PSFCH from a network node, the at least one parameter of the PSFCH including at least one of a number of duplications of the PSFCH or a number of PRBs for the PSFCH. Here, the at least one parameter may indicate to the UE to transmit the SL transmission in the at least one RB set associated with the plurality of LBT bandwidths other than the first LBT bandwidth of the PSSCH. For example, at 918, the Rx UE 903 may receive at least one parameter of the PSFCH from a network node 904, the at least one parameter of the PSFCH including at least one of a number of duplications of the PSFCH or a number of PRBs for the PSFCH. Furthermore, 1218 may be performed by the SL component 198.

At 1214, the UE may receive a SL transmission in a PSSCH from the Tx UE, the PSSCH including a plurality of LBT bandwidths associated with at least one RB set. Here, the first LBT bandwidth may be at least one failed LBT bandwidth that corresponds to the first measurement of the first LBT bandwidth being greater than the threshold value. For example, at 914, the Rx UE 903 may receive a SL transmission in a PSSCH from the Tx UE 902, the PSSCH including a plurality of LBT bandwidths associated with at least one RB set. Furthermore, 1214 may be performed by the SL component 198.

In one aspect, the at least one RB set associated with the plurality of LBT bandwidths other than the first LBT bandwidth of the PSSCH may include a plurality of LBT bandwidths continuously configured in a frequency domain, and the SL transmission may be transmitted in the plurality of LBT bandwidths continuously configured in the frequency domain. In one example, the plurality of LBT bandwidths continuously configured in the frequency domain may include a primary channel including SCI-1. In another example, the plurality of LBT bandwidths continuously configured in the frequency domain may not include a primary channel, and each LBT bandwidth of the plurality of LBT bandwidths may include SCI-1. In another example, the plurality of LBT bandwidths continuously configured in the frequency domain may not include a primary channel, and each LBT bandwidth of the plurality of LBT bandwidths may include SCI-1. In another example, the at least one RB set associated with the plurality of LBT bandwidths may include a plurality of LBT bandwidths discontinued in a frequency domain by the first LBT bandwidth, and each LBT bandwidth of the plurality of LBT bandwidths may include SCI-1.

In another aspect, the at least one parameter at 1008 may be associated with a first capability of the UE to prepare a waveform corresponding to the at least one RB set associated with the plurality of LBT bandwidths other than the first LBT bandwidth of the PSSCH. In one example, the SL transmission may be transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH.

In another aspect, the at least one parameter may be associated with a second capability of the UE to support SCI-1 repetition. In one example, the SL transmission may be transmitted in the at least one RB set associated with the plurality of LBT bandwidths including a plurality of LBT bandwidths continuously configured in a frequency domain and the plurality of LBT bandwidths including a primary channel, and the SL transmission may be transmitted based on the UE not having the second capability to support the SCI-1 repetition. In another example, the SL transmission may be transmitted in the at least one RB set associated with the plurality of LBT bandwidths including a plurality of LBT bandwidths continuously configured in a frequency domain and the plurality of LBT bandwidths not including a primary channel, where the SL transmission may be transmitted based on the UE having the second capability to support the SCI-1 repetition, and each LBT bandwidth of the plurality of LBT bandwidths may include the SCI-1 repetition. In another example, the SL transmission may be transmitted in the at least one RB set associated with the plurality of LBT bandwidths including a plurality of LBT bandwidths not continuously configured in a frequency domain based on the UE having the second capability to support the SCI-1 repetition, and each LBT bandwidth of the plurality of LBT bandwidths may include the SCI-1 repetition. In another example, the SL transmission may not be transmitted in the at least one RB set associated with the plurality of LBT bandwidths including a plurality of LBT bandwidths not continuously configured in a frequency domain or the plurality of LBT bandwidths not including a primary channel, and the SL transmission may be transmitted based on the UE not having the second capability to support the SCI-1 repetition.

In another aspect, the at least one parameter may be associated with a power consumption of the UE, and the SL transmission may not be transmitted in the at least one RB set associated with the plurality of LBT bandwidths other than the first LBT bandwidth of the PSSCH based on the power consumption of the UE being configured lower than a power threshold value.

In another aspect, the SL transmission transmitted in the at least one RB set associated with the plurality of LBT bandwidths other than the first LBT bandwidth of the PSSCH may include a SCI-1, and the SCI-1 may include an indication of the at least one RB set associated with the plurality of LBT bandwidths other than the first LBT bandwidth of the PSSCH. Here, the SCI-1 may include a bitmap indicating the at least one RB set associated with the plurality of LBT bandwidths other than the first LBT bandwidth of the PSSCH.

In another aspect, the SL transmission may include a SCI-2 mapped to multiple RB sets starting from a primary channel. In one example, the SL transmission may be transmitted in the at least one RB set associated with the plurality of LBT bandwidths including a plurality of LBT bandwidths continuously configured in a frequency domain, and the SL transmission may be transmitted based on the SCI-2 being mappable within the plurality of LBT bandwidths continuously configured in the frequency domain. In another example, the SL transmission may include a SCI-2 mapped to a single RB set in a primary channel, and the SCI-2 may be repeated in each LBT bandwidth of the plurality of LBT bandwidths.

At 1220, the UE may transmit a PSFCH including a HARQ feedback of the PSSCH, the PSFCH being mapped to a starting sub-channel of each RB set of the plurality of LBT bandwidths of the PSSCH. The PSFCH may be transmitted based on the at least one parameter of the PSFCH. The at least one parameter may be associated with at least one metric at the Rx UE, the at least one metric including: a CBR, a LBT success rate before the PSFCH; or an inter-RAT RSSI. For example, at 920, the Rx UE 903 may transmit a PSFCH including a HARQ feedback of the PSSCH. Furthermore, 1220 may be performed by the SL component 198.

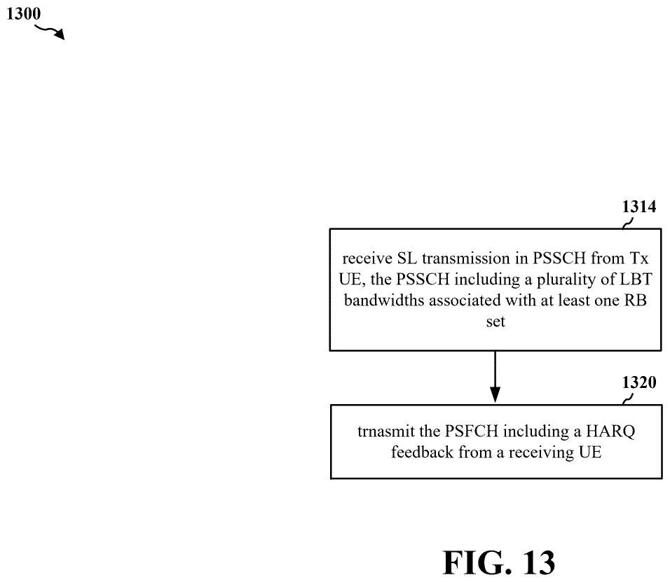

FIG. 13 is a flowchart 1300 of a method of wireless communication. The method may be performed by a UE (e.g., the UE 104; the Rx UE 903; the apparatus 1604). The UE may be a RX UE configured to receive a SL transmission in a PSSCH from a Tx UE, the PSSCH including a plurality of LBT bandwidths associated with at least one RB set, and transmit a PSFCH including a HARQ feedback of the PSSCH, the PSFCH being mapped to a starting sub-channel of each RB set of the plurality of LBT bandwidths of the PSSCH.

At 1314, the UE may receive a SL transmission in a PSSCH from the Tx UE, the PSSCH including a plurality of LBT bandwidths associated with at least one RB set. Here, the first LBT bandwidth may be at least one failed LBT bandwidth that corresponds to the first measurement of the first LBT bandwidth being greater than the threshold value. For example, at 914, the Rx UE 903 may receive a SL transmission in a PSSCH from the Tx UE 902, the PSSCH including a plurality of LBT bandwidths associated with at least one RB set. Furthermore, 1314 may be performed by the SL component 198.

In one aspect, the at least one RB set associated with the plurality of LBT bandwidths other than the first LBT bandwidth of the PSSCH may include a plurality of LBT bandwidths continuously configured in a frequency domain, and the SL transmission may be transmitted in the plurality of LBT bandwidths continuously configured in the frequency domain. In one example, the plurality of LBT bandwidths continuously configured in the frequency domain may include a primary channel including SCI-1. In another example, the plurality of LBT bandwidths continuously configured in the frequency domain may not include a primary channel, and each LBT bandwidth of the plurality of LBT bandwidths may include SCI-1. In another example, the plurality of LBT bandwidths continuously configured in the frequency domain may not include a primary channel, and each LBT bandwidth of the plurality of LBT bandwidths may include SCI-1. In another example, the at least one RB set associated with the plurality of LBT bandwidths may include a plurality of LBT bandwidths discontinued in a frequency domain by the first LBT bandwidth, and each LBT bandwidth of the plurality of LBT bandwidths may include SCI-1.

In another aspect, the at least one parameter at 1008 may be associated with a first capability of the UE to prepare a waveform corresponding to the at least one RB set associated with the plurality of LBT bandwidths other than the first LBT bandwidth of the PSSCH. In one example, the SL transmission may be transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH.

In another aspect, the at least one parameter may be associated with a second capability of the UE to support SCI-1 repetition. In one example, the SL transmission may be transmitted in the at least one RB set associated with the plurality of LBT bandwidths including a plurality of LBT bandwidths continuously configured in a frequency domain and the plurality of LBT bandwidths including a primary channel, and the SL transmission may be transmitted based on the UE not having the second capability to support the SCI-1 repetition. In another example, the SL transmission may be transmitted in the at least one RB set associated with the plurality of LBT bandwidths including a plurality of LBT bandwidths continuously configured in a frequency domain and the plurality of LBT bandwidths not including a primary channel, where the SL transmission may be transmitted based on the UE having the second capability to support the SCI-1 repetition, and each LBT bandwidth of the plurality of LBT bandwidths may include the SCI-1 repetition. In another example, the SL transmission may be transmitted in the at least one RB set associated with the plurality of LBT bandwidths including a plurality of LBT bandwidths not continuously configured in a frequency domain based on the UE having the second capability to support the SCI-1 repetition, and each LBT bandwidth of the plurality of LBT bandwidths may include the SCI-1 repetition. In another example, the SL transmission may not be transmitted in the at least one RB set associated with the plurality of LBT bandwidths including a plurality of LBT bandwidths not continuously configured in a frequency domain or the plurality of LBT bandwidths not including a primary channel, and the SL transmission may be transmitted based on the UE not having the second capability to support the SCI-1 repetition.

In another aspect, the at least one parameter may be associated with a power consumption of the UE, and the SL transmission may not be transmitted in the at least one RB set associated with the plurality of LBT bandwidths other than the first LBT bandwidth of the PSSCH based on the power consumption of the UE being configured lower than a power threshold value.

In another aspect, the SL transmission transmitted in the at least one RB set associated with the plurality of LBT bandwidths other than the first LBT bandwidth of the PSSCH may include a SCI-1, and the SCI-1 may include an indication of the at least one RB set associated with the plurality of LBT bandwidths other than the first LBT bandwidth of the PSSCH. Here, the SCI-1 may include a bitmap indicating the at least one RB set associated with the plurality of LBT bandwidths other than the first LBT bandwidth of the PSSCH.

In another aspect, the SL transmission may include a SCI-2 mapped to multiple RB sets starting from a primary channel. In one example, the SL transmission may be transmitted in the at least one RB set associated with the plurality of LBT bandwidths including a plurality of LBT bandwidths continuously configured in a frequency domain, and the SL transmission may be transmitted based on the SCI-2 being mappable within the plurality of LBT bandwidths continuously configured in the frequency domain. In another example, the SL transmission may include a SCI-2 mapped to a single RB set in a primary channel, and the SCI-2 may be repeated in each LBT bandwidth of the plurality of LBT bandwidths.

At 1320, the UE may transmit a PSFCH including a HARQ feedback of the PSSCH, the PSFCH being mapped to a starting sub-channel of each RB set of the plurality of LBT bandwidths of the PSSCH. The PSFCH may be transmitted based on the at least one parameter of the PSFCH. The at least one parameter may be associated with at least one metric at the Rx UE, the at least one metric including: a CBR, a LBT success rate before the PSFCH; or an inter-RAT RSSI. For example, at 920, the Rx UE 903 may transmit a PSFCH including a HARQ feedback of the PSSCH. Furthermore, 1320 may be performed by the SL component 198.

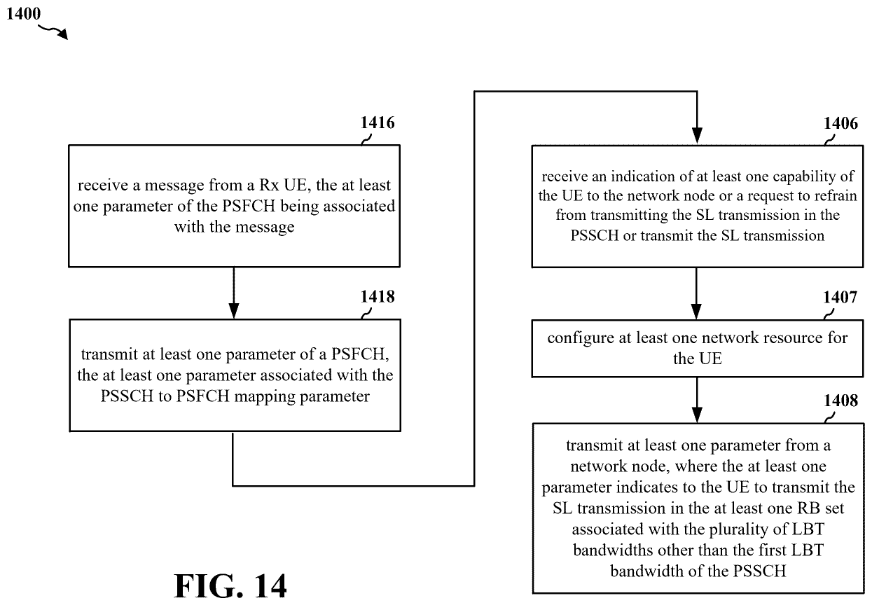

FIG. 14 is a flowchart 1400 of a method of wireless communication. The method may be performed by a network node (e.g., the base station 102; the network entity 904/1502). The network node may receive an indication of at least one capability of a UE or a request from the UE, and transmit at least one parameter for the UE based at least in part on receiving the indication of the at least one capability of the UE or the request from the UE, where the at least one parameter indicates to the UE to transmit the SL transmission in the at least one RB set associated with the plurality of LBT bandwidths other than the first LBT bandwidth of the PSSCH.

At 1416, the network node may receive a message from the Rx UE, the at least one parameter of the PSFCH being associated with the message. Here, the at least one parameter may be associated with at least one metric at the Rx UE, the at least one metric including a CBR, a LBT success rate before the PSFCH, or an inter-RAT RSSI. For example, at 916, the network node 904 may receive a message from the Rx UE 903, the at least one parameter of the PSFCH being associated with the message. Furthermore, 1416 may be performed by the SL configuring component 199.

At 1418, the network node may transmit at least one parameter of a PSFCH for the UE and/or the Rx UE. Here, the at least one parameter of a PSFCH may refer to a parameter may refer to a PSSCH to PSFCH mapping parameter. Here, the at least one parameter may indicate to the UE to transmit the SL transmission in the at least one RB set associated with the plurality of LBT bandwidths other than the first LBT bandwidth of the PSSCH. For example, at 918, the network node 904 may transmit at least one parameter of a PSFCH for the Tx UE 902 and/or the Rx UE 903. Furthermore, 1418 may be performed by the SL configuring component 199.

At 1406, the network node may receive an indication of at least one capability of a UE or a request from the UE. Here, the at least one parameter at 1408 may be associated with the at least one capability of the UE or the request transmitted to the network node. For example, at 906, the network node 904 may receive an indication of at least one capability of a Tx UE 902 or a request from the Tx UE 902. Furthermore, 1406 may be performed by a SL configuring component 199.

At 1407, the network node may configure at least one network resource for the UE, the at least one network resource is associated with the at least one parameter of PSSCH. For example, the network node may allocate a reduced number of RB sets and an increased number of slots to the UE implemented with the first PSSCH transmission policy of the all-or-nothing transmission. For example, at 907, the network node 904 may configure at least one network resource for the Tx UE 902, the at least one network resource is associated with the at least one parameter of PSSCH. Furthermore, 1207 may be performed by the SL configuring component 199.

At 1408, the network node may transmit at least one parameter for the UE based at least in part on receiving the indication of the at least one capability of the UE or the request from the UE. For example, at 908, the network node 904 may transmit at least one parameter for the Tx UE 902 based at least in part on receiving the indication of the at least one capability of the Tx UE 902 or the request from the Tx UE 902. Furthermore, 1408 may be performed by the SL configuring component 199.

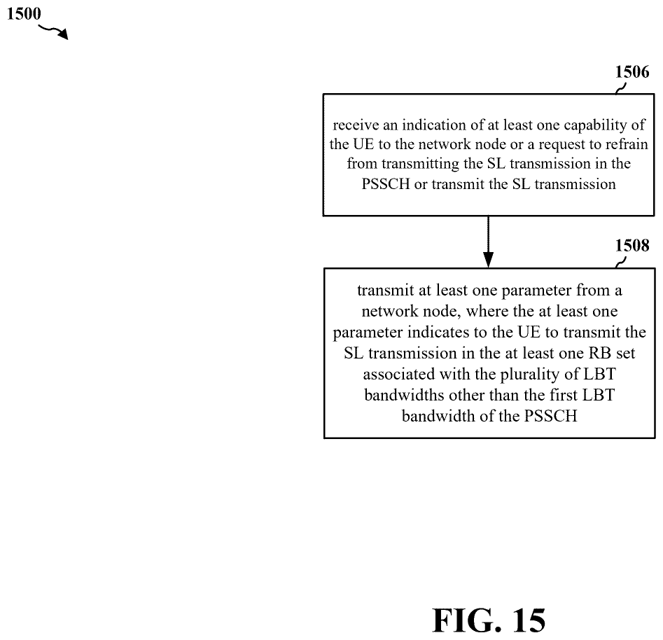

FIG. 15 is a flowchart 1500 of a method of wireless communication. The method may be performed by a network node (e.g., the base station 102; the network entity 904/1502). The network node may receive an indication of at least one capability of a UE or a request from the UE, and transmit at least one parameter for the UE based at least in part on receiving the indication of the at least one capability of the UE or the request from the UE, where the at least one parameter indicates to the UE to transmit the SL transmission in the at least one RB set associated with the plurality of LBT bandwidths other than the first LBT bandwidth of the PSSCH.

At 1506, the network node may receive an indication of at least one capability of a UE or a request from the UE. Here, the at least one parameter at 1508 may be associated with the at least one capability of the UE or the request transmitted to the network node. For example, at 906, the network node 904 may receive an indication of at least one capability of a Tx UE 902 or a request from the Tx UE 902. Furthermore, 1506 may be performed by a SL configuring component 199.

At 1508, the network node may transmit at least one parameter for the UE based at least in part on receiving the indication of the at least one capability of the UE or the request from the UE. For example, at 908, the network node 904 may transmit at least one parameter for the Tx UE 902 based at least in part on receiving the indication of the at least one capability of the Tx UE 902 or the request from the Tx UE 902. Furthermore, 1508 may be performed by the SL configuring component 199.

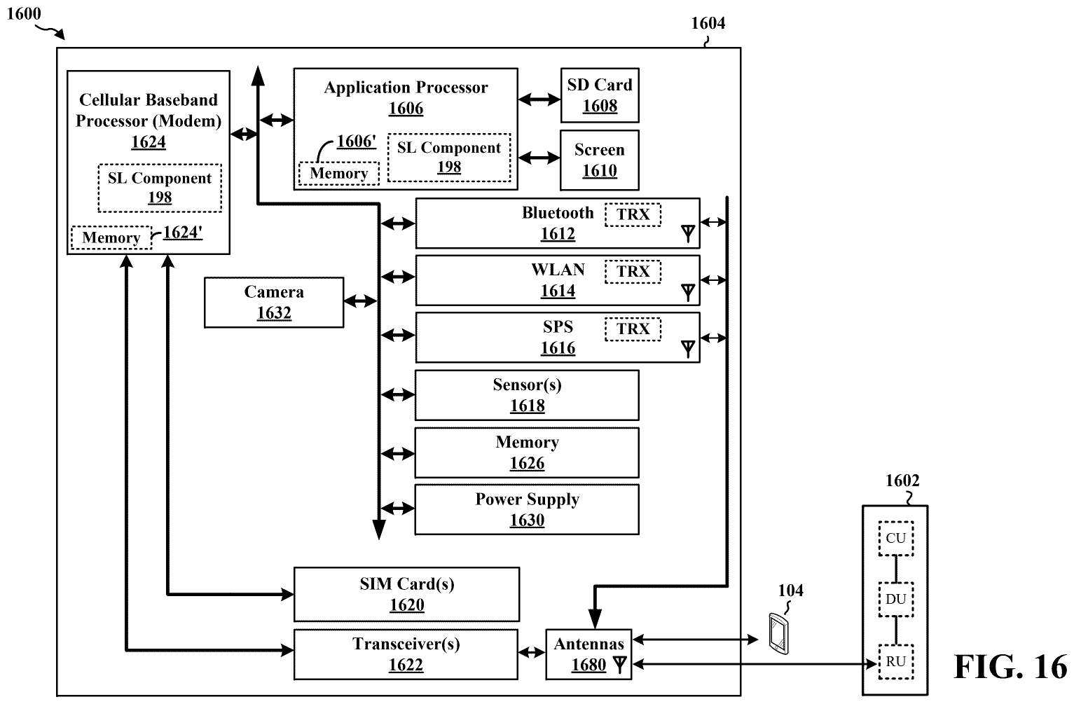

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the component 198 is configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. Here, the apparatus 1604 may be Tx UE. In one configuration, the apparatus 1604, and in particular the cellular baseband processor 1624 and/or the application processor 1606, includes means for measuring each of a plurality of LBT bandwidths of a PSSCH, and means for refraining from transmitting a SL transmission in the PSSCH or transmitting the SL transmission in at least one RB set associated with the plurality of LBT bandwidths other than a first LBT bandwidth of the PSSCH, where the SL transmission is transmitted or refrained from being transmitted based on a first measurement of the first LBT bandwidth of the PSSCH being greater than a threshold value. In one configuration, the at least one RB set associated with the plurality of LBT bandwidths other than the first LBT bandwidth of the PSSCH includes a plurality of LBT bandwidths continuously configured in a frequency domain, the SL transmission is transmitted in the plurality of LBT bandwidths continuously configured in the frequency domain, and the first LBT bandwidth is at least one failed LBT bandwidth that corresponds to the first measurement of the first LBT bandwidth being greater than the threshold value. In one configuration, the plurality of LBT bandwidths continuously configured in the frequency domain includes a primary channel including SL control information SCI-1. In one configuration, the plurality of LBT bandwidths continuously configured in the frequency domain does not include a primary channel, and each LBT bandwidth of the plurality of LBT bandwidths includes SL control information SCI-1. In one configuration, the at least one RB set associated with the plurality of LBT bandwidths includes a plurality of LBT bandwidths discontinued in a frequency domain by the first LBT bandwidth, and each LBT bandwidth of the plurality of LBT bandwidths includes SL control information SCI-1. In one configuration, the apparatus 1604, and in particular the cellular baseband processor 1624 and/or the application processor 1606, further includes means for receiving at least one parameter from a network node, where the at least one parameter indicates to the UE to transmit the SL transmission in the at least one RB set associated with the plurality of LBT bandwidths other than the first LBT bandwidth of the PSSCH. In one configuration, the apparatus 1604, and in particular the cellular baseband processor 1624 and/or the application processor 1606, further includes means for transmitting an indication of at least one capability of the UE to the network node, where the at least one parameter is associated with the at least one capability of the UE. In one configuration, the at least one parameter is associated with a first capability of the UE to prepare a waveform corresponding to the at least one RB set associated with the plurality of LBT bandwidths other than the first LBT bandwidth of the PSSCH, and the SL transmission is transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH. In one configuration, the at least one parameter is associated with a second capability of the UE to support SL control information SCI-1 repetition. In one configuration, the SL transmission is transmitted in the at least one RB set associated with the plurality of LBT bandwidths including a plurality of LBT bandwidths continuously configured in a frequency domain and the plurality of LBT bandwidths including a primary channel, and the SL transmission is transmitted based on the UE not having the second capability to support the SCI-1 repetition. In one configuration, the SL transmission is transmitted in the at least one RB set associated with the plurality of LBT bandwidths including a plurality of LBT bandwidths continuously configured in a frequency domain and the plurality of LBT bandwidths not including a primary channel, where the SL transmission is transmitted based on the UE having the second capability to support the SCI-1 repetition, and each LBT bandwidth of the plurality of LBT bandwidths includes the SCI-1 repetition. In one configuration, the SL transmission is transmitted in the at least one RB set associated with the plurality of LBT bandwidths including a plurality of LBT bandwidths not continuously configured in a frequency domain based on the UE having the second capability to support the SCI-1 repetition, and each LBT bandwidth of the plurality of LBT bandwidths includes the SCI-1 repetition. In one configuration, the SL transmission is not transmitted in the at least one RB set associated with the plurality of LBT bandwidths including a plurality of LBT bandwidths not continuously configured in a frequency domain or the plurality of LBT bandwidths not including a primary channel, where the SL transmission is transmitted based on the UE not having the second capability to support the SCI-1 repetition. In one configuration, the at least one parameter is associated with a power consumption of the UE, and the SL transmission is not transmitted in the at least one RB set associated with the plurality of LBT bandwidths other than the first LBT bandwidth of the PSSCH based on the power consumption of the UE being configured lower than a power threshold value. In one configuration, the apparatus 1604, and in particular the cellular baseband processor 1624 and/or the application processor 1606, further includes means for transmitting a request to refrain from transmitting the SL transmission in the PSSCH or transmit the SL transmission in at least one RB set associated with the plurality of LBT bandwidths other than the first LBT bandwidth of the PSSCH, where the at least one parameter is associated with the request, the request being transmitted to the network node. In one configuration, the SL transmission transmitted in the at least one RB set associated with the plurality of LBT bandwidths other than the first LBT bandwidth of the PSSCH includes a SL control information SCI-1, and the SCI-1 includes an indication of the at least one RB set associated with the plurality of LBT bandwidths other than the first LBT bandwidth of the PSSCH. In one configuration, the SCI-1 includes a bitmap indicating the at least one RB set associated with the plurality of LBT bandwidths other than the first LBT bandwidth of the PSSCH. In one configuration, the SL transmission includes a SL control information SCI-2 mapped to multiple RB sets starting from a primary channel, and the SL transmission is transmitted in the at least one RB set associated with the plurality of LBT bandwidths including a plurality of LBT bandwidths continuously configured in a frequency domain, where the SL transmission is transmitted based on the SCI-2 being mappable within the plurality of LBT bandwidths continuously configured in the frequency domain. In one configuration, the SL transmission includes a SL control information SCI-2 mapped to a single RB set in a primary channel, and the SCI-2 is repeated in each LBT bandwidth of the plurality of LBT bandwidths. In one configuration, the apparatus 1604, and in particular the cellular baseband processor 1624 and/or the application processor 1606, further includes means for receiving at least one parameter of a PSFCH, and means for receiving the PSFCH including a HARQ feedback from a receiving UE, where the at least one parameter is associated with at least one metric at the receiving UE, the at least one metric including a CBR, a LBT success rate before the PSFCH, or an inter-RAT RSSI.

The apparatus 1604 may be Rx UE. In one configuration, the apparatus 1604, and in particular the cellular baseband processor 1624 and/or the application processor 1606, includes means for receiving a SL transmission in a PSSCH from a Tx UE, the PSSCH including a plurality of LBT bandwidths associated with at least one RB set, and means for transmitting a PSFCH including a HARQ feedback of the PSSCH, the PSFCH being mapped to a starting sub-channel of each RB set of the plurality of LBT bandwidths of the PSSCH. In one configuration, the apparatus 1604, and in particular the cellular baseband processor 1624 and/or the application processor 1606, further includes means for receiving at least one parameter of the PSFCH from a network node, the at least one parameter of the PSFCH including at least one of a number of duplications of the PSFCH or a number of PRBs for the PSFCH, where the PSFCH is transmitted based on the at least one parameter of the PSFCH. In one configuration, the at least one parameter is associated with at least one metric at the UE, the at least one metric including a CBR, a LBT success rate before the PSFCH, or an inter-RAT RSSI.

The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

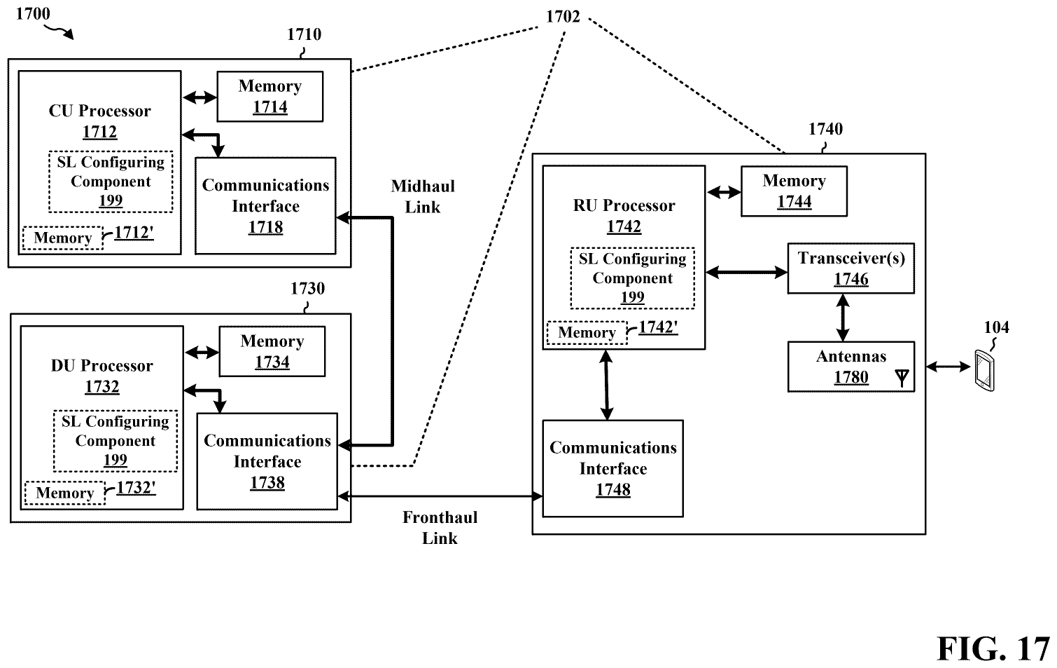

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include a CU processor 1712. The CU processor 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include a DU processor 1732. The DU processor 1732 may include on-chip memory 1732′. In some aspects, the DU 1730 may further include additional memory modules 1734 and a communications interface 1738. The DU 1730 communicates with the RU 1740 through a fronthaul link. The RU 1740 may include an RU processor 1742. The RU processor 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive an indication of at least one capability of a UE or a request from the UE, and transmit at least one parameter for the UE based at least in part on receiving the indication of the at least one capability of the UE or the request from the UE, where the at least one parameter indicates to the UE to transmit the SL transmission in the at least one RB set associated with the plurality of LBT bandwidths other than the first LBT bandwidth of the PSSCH. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1702 may include a variety of components configured for various functions. In one configuration, the network entity 1702 includes means for transmitting at least one parameter for the UE based at least in part on receiving the indication of the at least one capability of the UE or the request from the UE, where the at least one parameter indicates to the UE to transmit SL transmission in at least one RB set associated with a plurality of LBT bandwidths other than a first LBT bandwidth of PSSCH based on a first measurement of the first LBT bandwidth of the PSSCH being greater than a threshold value. In one configuration, the network entity 1702 further includes means for configuring at least one network resource for the UE, the at least one network resource is associated with the at least one parameter of PSSCH. In one configuration, the network entity 1702 further includes means for transmitting at least one parameter of a PSFCH, the at least one parameter associated with the PSSCH to PSFCH mapping parameter. In one configuration, the network entity 1702 further includes means for receiving a message from a Rx UE, the at least one parameter of the PSFCH being associated with the message, where the message includes at least one metric including a CBR, a LBT success rate before the PSFCH, or an inter-RAT RSSI. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of the current disclosure, a UE may be configured to measure each of a plurality of LBT bandwidths of a PSSCH, and refrain from transmitting a SL transmission in the PSSCH or transmit the SL transmission in at least one RB set associated with the plurality of LBT bandwidths other than a first LBT bandwidth of the PSSCH, where the SL transmission may be transmitted or refrained from being transmitted based on a first measurement of the first LBT bandwidth of the PSSCH being greater than a threshold value. The network node may receive an indication of at least one capability of a UE or a request from the UE, and transmit at least one parameter for the UE based at least in part on receiving the indication of the at least one capability of the UE or the request from the UE, where the at least one parameter may indicate to the UE to transmit the SL transmission in the at least one RB set associated with the plurality of LBT bandwidths other than the first LBT bandwidth of the PSSCH.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including measuring each of a plurality of LBT bandwidths of a PSSCH, and refraining from transmitting a SL transmission in the PSSCH or transmitting the SL transmission in at least one RB set associated with the plurality of LBT bandwidths other than first LBT bandwidth of the PSSCH, where the SL transmission is transmitted or refrained from being transmitted based on a first measurement of the first LBT bandwidth of the PSSCH being greater than a threshold value.

Aspect 2 is the method of aspect 1, where the at least one RB set associated with the plurality of LBT bandwidths other than the first LBT bandwidth of the PSSCH includes a plurality of LBT bandwidths continuously configured in a frequency domain, and the SL transmission is transmitted in the plurality of LBT bandwidths continuously configured in the frequency domain, where the first LBT bandwidth may be at least one failed LBT bandwidth that corresponds to the first measurement of the first LBT bandwidth being greater than the threshold value.

Aspect 3 is the method of any of aspects 1 and 2, where the plurality of LBT bandwidths continuously configured in the frequency domain includes a primary channel including SL control information SCI-1.

Aspect 4 is the method of any of aspects 2 and 3, where the plurality of LBT bandwidths continuously configured in the frequency domain does not include a primary channel, and each LBT bandwidth of the plurality of LBT bandwidths includes SL control information SCI-1.

Aspect 5 is the method of any of aspects 1 to 4, where the at least one RB set associated with the plurality of LBT bandwidths includes a plurality of LBT bandwidths discontinued in a frequency domain by the first LBT bandwidth, and each LBT bandwidth of the plurality of LBT bandwidths includes SL control information SCI-1.

Aspect 6 is the method of any of aspects 1 to 5, further including receiving at least one parameter from a network node, where the at least one parameter indicates to the UE to transmit the SL transmission in the at least one RB set associated with the plurality of LBT bandwidths other than the first LBT bandwidth of the PSSCH.

Aspect 7 is the method of aspect 6, further including transmitting an indication of at least one capability of the UE to the network node, where the at least one parameter is associated with the at least one capability of the UE.

Aspect 8 is the method of any of aspects 6 and 7, where the at least one parameter is associated with a first capability of the UE to prepare a waveform corresponding to the at least one RB set associated with the plurality of LBT bandwidths other than the first LBT bandwidth of the PSSCH, and the SL transmission is transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH.

Aspect 9 is the method of any of aspects 6 to 8, where the at least one parameter is associated with a second capability of the UE to support SL control information SCI-1 repetition.

Aspect 10 is the method of aspect 9, where the SL transmission is transmitted in the at least one RB set associated with the plurality of LBT bandwidths including a plurality of LBT bandwidths continuously configured in a frequency domain and the plurality of LBT bandwidths including a primary channel, and the SL transmission is transmitted based on the UE not having the second capability to support the SCI-1 repetition.

Aspect 11 is the method of any of aspects 9 and 10, where the SL transmission is transmitted in the at least one RB set associated with the plurality of LBT bandwidths including a plurality of LBT bandwidths continuously configured in a frequency domain and the plurality of LBT bandwidths not including a primary channel, where the SL transmission is transmitted based on the UE having the second capability to support the SCI-1 repetition, and each LBT bandwidth of the plurality of LBT bandwidths includes the SCI-1 repetition.

Aspect 12 is the method of any of aspects 9 to 11, where the SL transmission is transmitted in the at least one RB set associated with the plurality of LBT bandwidths including a plurality of LBT bandwidths not continuously configured in a frequency domain based on the UE having the second capability to support the SCI-1 repetition, and each LBT bandwidth of the plurality of LBT bandwidths includes the SCI-1 repetition.

Aspect 13 is the method of any of aspects 9 to 12, where the SL transmission is not transmitted in the at least one RB set associated with the plurality of LBT bandwidths including a plurality of LBT bandwidths not continuously configured in a frequency domain or the plurality of LBT bandwidths not including a primary channel, where the SL transmission is transmitted based on the UE not having the second capability to support the SCI-1 repetition.

Aspect 14 is the method of any of aspects 6 to 13, where the at least one parameter is associated with a power consumption of the UE, and the SL transmission is not transmitted in the at least one RB set associated with the plurality of LBT bandwidths other than the first LBT bandwidth of the PSSCH based on the power consumption of the UE being configured lower than a power threshold value.

Aspect 15 is the method of any of aspects 6 to 14, further including transmitting a request to refrain from transmitting the SL transmission in the PSSCH or transmit the SL transmission in at least one RB set associated with the plurality of LBT bandwidths other than the first LBT bandwidth of the PSSCH, where the at least one parameter is associated with the request, the request being transmitted to the network node.

Aspect 16 is the method of any of aspects 1 to 15, where the SL transmission transmitted in the at least one RB set associated with the plurality of LBT bandwidths other than the first LBT bandwidth of the PSSCH includes a SL control information SCI-1, and the SCI-1 includes an indication of the at least one RB set associated with the plurality of LBT bandwidths other than the first LBT bandwidth of the PSSCH.

Aspect 17 is the method of aspect 16, where the SCI-1 includes a bitmap indicating the at least one RB set associated with the plurality of LBT bandwidths other than the first LBT bandwidth of the PSSCH.

Aspect 18 is the method of any of aspects 1 to 17, where the SL transmission includes a SL control information SCI-2 mapped to multiple RB sets starting from a primary channel, and the SL transmission is transmitted in the at least one RB set associated with the plurality of LBT bandwidths including a plurality of LBT bandwidths continuously configured in a frequency domain, where the SL transmission is transmitted based on the SCI-2 being mappable within the plurality of LBT bandwidths continuously configured in the frequency domain.

Aspect 19 is the method of any of aspects 1 to 18, where the SL transmission includes a SL control information SCI-2 mapped to a single RB set in a primary channel, and the SCI-2 is repeated in each LBT bandwidth of the plurality of LBT bandwidths.

Aspect 20 is the method of any of aspects 1 to 19, further including receiving at least one parameter of a PSFCH, and receiving the PSFCH including a HARQ feedback from a receiving UE, where the at least one parameter is associated with at least one metric at the receiving UE, the at least one metric including a CBR, a LBT success rate before the PSFCH, or an inter-RAT RSSI.

Aspect 21 is an apparatus for wireless communication including at least one processor coupled to a memory and configured to implement any of aspects 1 to 20, further including a transceiver coupled to the at least one processor.

Aspect 22 is an apparatus for wireless communication including means for implementing any of aspects 1 to 20.

Aspect 23 is a non-transitory computer-readable medium storing computer executable code, where the code when executed by a processor causes the processor to implement any of aspects 1 to 20.

Aspect 24 is a method of wireless communication at a UE, comprising receiving a SL transmission in a PSSCH from a Tx UE, the PSSCH including a plurality of LBT bandwidths associated with at least one RB set, and transmitting a PSFCH including a HARQ feedback of the PSSCH, the PSFCH being mapped to a starting sub-channel of each RB set of the plurality of LBT bandwidths of the PSSCH.

Aspect 25 is the method of aspect 24, further including receiving at least one parameter of the PSFCH from a network node, the at least one parameter of the PSFCH including at least one of a number of duplications of the PSFCH or a number of PRBs for the PSFCH, where the PSFCH is transmitted based on the at least one parameter of the PSFCH.

Aspect 26 is the method of aspect 25, where the at least one parameter is associated with at least one metric at the UE, the at least one metric including a CBR, a LBT success rate before the PSFCH, or an inter-RAT RSSI.

Aspect 27 is an apparatus for wireless communication including at least one processor coupled to a memory and configured to implement any of aspects 24 to 26, further including a transceiver coupled to the at least one processor.

Aspect 28 is an apparatus for wireless communication including means for implementing any of aspects 24 to 26.

Aspect 29 is a non-transitory computer-readable medium storing computer executable code, where the code when executed by a processor causes the processor to implement any of aspects 24 to 26.

Aspect 30 is a method of wireless communication at a network node, including receiving an indication of at least one capability of a UE or a request from the UE, and transmitting at least one parameter for the UE based at least in part on receiving the indication of the at least one capability of the UE or the request from the UE, where the at least one parameter indicates to the UE to transmit SL transmission in at least one RB set associated with a plurality of LBT bandwidths other than a first LBT bandwidth of PSSCH based on a first measurement of the first LBT bandwidth of the PSSCH being greater than a threshold value.

Aspect 31 is the method of aspect 30, further including configuring at least one network resource for the UE, the at least one network resource is associated with the at least one parameter of PSSCH.

Aspect 32 is the method of any of aspects 30 and 31, further including transmitting at least one parameter of a PSFCH, the at least one parameter associated with the PSSCH to PSFCH mapping parameter.

Aspect 33 is the method of aspect 32, further including receiving a message from a Rx UE, the at least one parameter of the PSFCH being associated with the message, where the message includes at least one metric including a CBR, a LBT success rate before the PSFCH, or an inter-RAT RSSI.

Aspect 34 is an apparatus for wireless communication including at least one processor coupled to a memory and configured to implement any of aspects 30 to 33, further including a transceiver coupled to the at least one processor.

Aspect 35 is an apparatus for wireless communication including means for implementing any of aspects 30 to 33.

Aspect 36 is a non-transitory computer-readable medium storing computer executable code, where the code when where executed by a processor causes the processor to implement any of aspects 30 to 33.

What is claimed is:

1. An apparatus for wireless communication at a user equipment (UE), comprising:
a memory; and
at least one processor coupled to the memory and, based at least in part on information stored in the memory, the at least one processor is configured to:
measure each of a plurality of listen-before-talk (LBT) bandwidths of a physical sidelink shared channel (PSSCH); and
refrain from transmitting a sidelink (SL) transmission in the PSSCH or transmit the SL transmission in at least one resource block (RB) set associated with the plurality of LBT bandwidths other than a first LBT bandwidth of the PSSCH, wherein the SL transmission is transmitted or refrained from being transmitted based on a first measurement of the first LBT bandwidth of the PSSCH being greater than a threshold value.

2. The apparatus of claim 1, wherein the at least one resource block (RB) set associated with the plurality of LBT bandwidths other than the first LBT bandwidth of the PSSCH includes a plurality of LBT bandwidths continuously configured in a frequency domain,
wherein the SL transmission is transmitted in the plurality of LBT bandwidths continuously configured in the frequency domain,
wherein the first LBT bandwidth is at least one failed LBT bandwidth that corresponds to the first measurement of the first LBT bandwidth being greater than the threshold value.

3. The apparatus of claim 2, wherein the plurality of LBT bandwidths continuously configured in the frequency domain includes a primary channel including SL control information (SCI) format 1 (SCI-1).

4. The apparatus of claim 2, wherein the plurality of LBT bandwidths continuously configured in the frequency domain does not include a primary channel, and each LBT bandwidth of the plurality of LBT bandwidths includes SL control information (SCI) format 1 (SCI-1).

5. The apparatus of claim 1, wherein the at least one resource block (RB) set associated with the plurality of LBT bandwidths includes a plurality of LBT bandwidths discontinued in a frequency domain by the first LBT bandwidth, and each LBT bandwidth of the plurality of LBT bandwidths includes SL control information (SCI) format 1 (SCI-1).

6. The apparatus of claim 1, wherein the at least one processor is further configured to:
receive at least one parameter from a network node, wherein the at least one parameter indicates to the UE to transmit the SL transmission in the at least one resource block (RB) set associated with the plurality of LBT bandwidths other than the first LBT bandwidth of the PSSCH.

7. The apparatus of claim 6, wherein the at least one processor is further configured to:
transmit an indication of at least one capability of the UE to the network node, wherein the at least one parameter is associated with the at least one capability of the UE.

8. The apparatus of claim 6, wherein the at least one parameter is associated with a first capability of the UE to prepare a waveform corresponding to the at least one RB set associated with the plurality of LBT bandwidths other than the first LBT bandwidth of the PSSCH,
wherein the SL transmission is transmitted in the at least one RB set associated with the plurality of LBT bandwidths other than the first LBT bandwidth of the PSSCH based on the UE having the first capability to prepare the waveform corresponding to the at least one RB set associated with the plurality of LBT bandwidths other than the first LBT bandwidth of the PSSCH.

9. The apparatus of claim 6, wherein the at least one parameter is associated with a second capability of the UE to support SL control information (SCI) format 1 (SCI-1) repetition.

10. The apparatus of claim 9, wherein the SL transmission is transmitted in the at least one RB set associated with the plurality of LBT bandwidths including a plurality of LBT bandwidths continuously configured in a frequency domain and the plurality of LBT bandwidths including a primary channel, wherein the SL transmission is transmitted based on the UE not having the second capability to support the SCI-1 repetition.

11. The apparatus of claim 9, wherein the SL transmission is transmitted in the at least one RB set associated with the plurality of LBT bandwidths including a plurality of LBT bandwidths continuously configured in a frequency domain and the plurality of LBT bandwidths not including a primary channel, wherein the SL transmission is transmitted based on the UE having the second capability to support the SCI-1 repetition,
wherein each LBT bandwidth of the plurality of LBT bandwidths includes the SCI-1 repetition.

12. The apparatus of claim 9, wherein the SL transmission is transmitted in the at least one RB set associated with the plurality of LBT bandwidths including a plurality of LBT bandwidths not continuously configured in a frequency domain based on the UE having the second capability to support the SCI-1 repetition,
wherein each LBT bandwidth of the plurality of LBT bandwidths includes the SCI-1 repetition.

13. The apparatus of claim 9, wherein the SL transmission is not transmitted in the at least one RB set associated with the plurality of LBT bandwidths including a plurality of LBT bandwidths not continuously configured in a frequency domain or the plurality of LBT bandwidths not including a primary channel, wherein the SL transmission is transmitted based on the UE not having the second capability to support the SCI-1 repetition.

14. The apparatus of claim 6, wherein the at least one parameter is associated with a power consumption of the UE,
wherein the SL transmission is not transmitted in the at least one RB set associated with the plurality of LBT bandwidths other than the first LBT bandwidth of the PSSCH based on the power consumption of the UE being configured lower than a power threshold value.

15. The apparatus of claim 6, wherein the at least one processor is further configured to transmit a request to refrain from transmitting the SL transmission in the PSSCH or transmit the SL transmission in at least one RB set associated with the plurality of LBT bandwidths other than the first LBT bandwidth of the PSSCH,
wherein the at least one parameter is associated with the request, the request being transmitted to the network node.

16. The apparatus of claim 1, wherein the SL transmission transmitted in the at least one RB set associated with the plurality of LBT bandwidths other than the first LBT bandwidth of the PSSCH includes a SL control information (SCI) format 1 (SCI-1), and the SCI-1 includes an indication of the at least one RB set associated with the plurality of LBT bandwidths other than the first LBT bandwidth of the PSSCH.

17. The apparatus of claim 16, wherein the SCI-1 includes a bitmap indicating the at least one RB set associated with the plurality of LBT bandwidths other than the first LBT bandwidth of the PSSCH.

18. The apparatus of claim 1, wherein the SL transmission includes a SL control information (SCI) format 2 (SCI-2) mapped to multiple RB sets starting from a primary channel,
wherein the SL transmission is transmitted in the at least one RB set associated with the plurality of LBT bandwidths including a plurality of LBT bandwidths continuously configured in a frequency domain, wherein the SL transmission is transmitted based on the SCI-2 being mappable within the plurality of LBT bandwidths continuously configured in the frequency domain.

19. The apparatus of claim 1, wherein the SL transmission includes a SL control information (SCI) format 2 (SCI-2) mapped to a single RB set in a primary channel, and the SCI-2 is repeated in each LBT bandwidth of the plurality of LBT bandwidths.

20. The apparatus of claim 1, wherein the at least one processor is further configured to:
receive at least one parameter of a physical sidelink feedback channel (PSFCH); and
receive the PSFCH including a hybrid automatic repeat request (HARQ) feedback from a receiving UE,
wherein the at least one parameter is associated with at least one metric at the receiving UE, the at least one metric including:
a channel busy ratio (CBR);
a LBT success rate before the PSFCH; or
an inter radio access technology (inter-RAT) received signal strength indicator (RSSI).

21. An apparatus for wireless communication at a user equipment (UE), comprising:
a memory; and
at least one processor coupled to the memory and, based at least in part on information stored in the memory, the at least one processor is configured to:
receive a sidelink (SL) transmission in a physical sidelink shared channel (PSSCH) from a transmit (Tx) UE, the PSSCH including a plurality of listen-before-talk (LBT) bandwidths associated with at least one resource block (RB) set; and
transmit a physical sidelink feedback channel (PSFCH) including a hybrid automatic repeat request (HARQ) feedback of the PSSCH, the PSFCH being mapped to a starting sub-channel of each RB set of the plurality of LBT bandwidths of the PSSCH.

22. The apparatus of claim 21, wherein the at least one processor is further configured to:
receive at least one parameter of the PSFCH from a network node, the at least one parameter of the PSFCH including at least one of a number of duplications of the PSFCH or a number of physical resource blocks (PRBs) for the PSFCH,
wherein the PSFCH is transmitted based on the at least one parameter of the PSFCH.

23. The apparatus of claim 22, wherein the at least one parameter is associated with at least one metric at the UE, the at least one metric including:
a channel busy ratio (CBR);
a LBT success rate before the PSFCH; or
an inter radio access technology (inter-RAT) received signal strength indicator (RSSI).

24. An apparatus for wireless communication at a network node, comprising:
a memory; and
at least one processor coupled to the memory and, based at least in part on information stored in the memory, the at least one processor is configured to:
receive an indication of at least one capability of a user equipment (UE) or a request from the UE; and
transmit at least one parameter for the UE based at least in part on receiving the indication of the at least one capability of the UE or the request from the UE, wherein the at least one parameter indicates to the UE to transmit sidelink (SL) transmission in at least one resource block (RB) set associated with a plurality of LBT bandwidths other than a first LBT bandwidth of physical sidelink shared channel (PSSCH) based on a first measurement of the first LBT bandwidth of the PSSCH being greater than a threshold value.

25. The apparatus of claim 24, wherein the at least one processor is further configured to:
configure at least one network resource for the UE, the at least one network resource is associated with the at least one parameter.

26. The apparatus of claim 24, wherein the at least one processor is further configured to:
transmit the at least one parameter of a PSFCH, the at least one parameter associated with the PSSCH to PSFCH mapping parameter.

27. The apparatus of claim 26, wherein the at least one processor is further configured to:
receive a message from a receiving (Rx) UE, the at least one parameter of the PSFCH being associated with the message,
wherein the message includes at least one metric including:
a channel busy ratio (CBR);
a LBT success rate before the PSFCH; or
an inter radio access technology (inter-RAT) received signal strength indicator (RSSI).

28. A method of wireless communication at a user equipment (UE), comprising:
measuring each of a plurality of listen-before-talk (LBT) bandwidths of a physical sidelink shared channel (PSSCH); and
refraining from transmitting a sidelink (SL) transmission in the PSSCH or transmitting the SL transmission in at least one resource block (RB) set associated with the plurality of LBT bandwidths other than a first LBT bandwidth of the PSSCH, wherein the SL transmission is transmitted or refrained from being transmitted based on a first measurement of the first LBT bandwidth of the PSSCH being greater than a threshold value.

29. The method of claim 28, further comprising:
receiving at least one parameter from a network node, wherein the at least one parameter indicates to the UE to transmit the SL transmission in the at least one resource block (RB) set associated with the plurality of LBT bandwidths other than the first LBT bandwidth of the PSSCH.

30. The method of claim 29, further comprising:
transmitting an indication of at least one capability of the UE to the network node, wherein the at least one parameter is associated with the at least one capability of the UE.
